(19) United States
(12) Patent Application Publication
(10) Pub. No.: US 2026/0246600 A1
(43) Pub. Date: Aug. 20, 2026

(54) SECONDARY CELL ACTIVATION FOR SWITCHED SUPPLEMENTAL DOWNLINK CARRIER AGGREGATION

(71) Applicant: QUALCOMM Incorporated, San Diego, CA (US)

(72) Inventors: Nazmul ISLAM, Littleton, MA (US); Changhwan PARK, San Diego, CA (US); Kazuki TAKEDA, Minato-ku (JP); Stefan BRUECK, Neunkirchen am Brand (DE); Timo Ville VINTOLA, San Diego, CA (US); Valentin Alexandru GHEORGHIU, Yokohama-shi (JP)

(21) Appl. No.: 19/390,146

(22) Filed: Nov. 14, 2025

Related U.S. Application Data
(60) Provisional application No. 63/758,751, filed on Feb. 14, 2025.

(51) Int. Cl. H04L 5/00

(52) U.S. Cl. CPC H04L 5/0098; H04L 5/0035; H04L 5/0051

(57) ABSTRACT

Various aspects of the present disclosure generally relate to wireless communication. In some aspects, a user equipment (UE) may receive, from a network node, a configuration for a primary cell (PCell) associated with a frequency division duplexing (FDD) carrier and a secondary cell (SCell) associated with a supplemental downlink (SDL) carrier. The UE may communicate with one or more of the PCell or the SCell based at least in part on an SCell activation status, wherein the communicating includes communicating only with the PCell or communicating only with the SCell in each transmission time interval (TTI). Numerous other aspects are described.

### CROSS-REFERENCE TO RELATED APPLICATION

This Patent Application claims priority to U.S. Provisional Patent Application No. 63/758,751, filed on February 14, 2025, entitled “SECONDARY CELL ACTIVATION FOR SWITCHED SUPPLEMENTAL DOWNLINK CARRIER AGGREGATION,” and assigned to the assignee hereof. The disclosure of the prior Application is considered part of and is incorporated by reference into this Patent Application.

### FIELD OF THE DISCLOSURE

Aspects of the present disclosure generally relate to wireless communication, and specifically relate to techniques, apparatuses, and methods associated with secondary cell activation for switched supplemental downlink carrier aggregation.

### DESCRIPTION OF THE RELATED TECHNOLOGY

Wireless communication systems are widely deployed to provide various services, which may involve carrying or supporting voice, text, other messaging, video, data, or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, or device transmit power, among other examples). Such multiple-access RATs are supported by technological advancements that have been adopted in various telecommunication standards, which define common protocols that enable different wireless communication devices to communicate on a local, municipal, national, regional, or global level. An example telecommunication standard is New Radio (NR). NR, which also may be referred to as 5G, is part of a continuous mobile broadband evolution promulgated by the Third Generation Partnership Project (3GPP). As the demand for connectivity continues to increase, further improvements in NR may be implemented, and other RATs, such as 6G and beyond, may be introduced to enable new applications and facilitate new use cases.

Carrier aggregation is a technology that enables two or more component carriers (sometimes referred to as carriers) to be combined (e.g., into a single channel) for a single user equipment (UE) to enhance data capacity. In carrier aggregation, combined carriers may be contiguous or non-contiguous, and carriers can be combined in the same frequency band, different frequency bands, or in different frequency ranges. For example, carrier aggregation may be configured in an intra-band contiguous mode, where the aggregated carriers are contiguous to one another and in the same band. Additionally, or alternatively, carrier aggregation may be configured in an intra-band non-contiguous mode where the aggregated carriers are non-contiguous and in the same band. Additionally, or alternatively, carrier aggregation may be configured in an inter-band non-contiguous mode where the aggregated carriers are non-contiguous and in different bands or different frequency ranges. In carrier aggregation, a UE may be configured with a primary carrier or a primary cell (PCell) and one or more secondary carriers or secondary cells (SCells). The PCell typically carries control information (e.g., downlink control information or scheduling information) for scheduling data communications on one or more SCells, which may be referred to as cross-carrier scheduling. In some cases, a carrier (e.g., a PCell or an SCell) may carry control information for scheduling data communications on the carrier, which may be referred to as self-carrier scheduling or carrier self-scheduling.

### SUMMARY

In a typical carrier aggregation configuration, multiple carriers are combined into a single channel to enhance data capacity. For example, in a supplemental downlink (SDL) configuration, a primary downlink carrier may be combined with an SDL carrier such that downlink data can be simultaneously transmitted to a single user equipment (UE) on multiple downlink carriers in order to enhance downlink capacity and significantly increase downlink speed and throughput. However, there are various scenarios where switching between a frequency division duplexing (FDD) band and an SDL carrier (e.g., using only the FDD band or only the SDL carrier at any given time) may be useful. For example, mid-band spectrum is most effective closer to a cell site, while low-band spectrum tends to propagate farther distances and is therefore useful at greater distances from cell sites. However, low-band spectrum often carries significant traffic volumes in urban (indoor) and rural areas, which may lead to congestion that severely degrades user experience. Although using a low-band SDL carrier with the ability to reach most poor coverage areas could potentially improve low-band performance, many low-band SDL carriers cannot be paired with a primary carrier that supports uplink communication. For example, some SDL carriers may fall within downlink and uplink spectrum associated with an FDD carrier (e.g., within a duplex gap or guard band), overlap with uplink spectrum, or have an insufficient or excessive separation from uplink spectrum.

Accordingly, in some cases, a carrier aggregation configuration may utilize switching, where a UE switches between communicating exclusively with a primary cell (PCell) associated with an FDD band that includes a downlink carrier and an uplink carrier, and communicating exclusively with a secondary cell (SCell) associated with an SDL band. For example, a UE that supports inter-carrier scheduling may monitor the downlink carrier associated with the PCell for downlink control information (DCI), which may schedule downlink transmissions via the SDL band in addition to the downlink carrier associated with the PCell. The UE may switch from communicating only with the PCell to communicating only with the SCell for a scheduled transmission interval, and may switch back to communicating with the PCell after the scheduled transmission interval in the SDL carrier. For example, the UE may switch between communicating with the PCell associated with the FDD band for a first duration and communicating with the SCell associated with the SDL band for a second duration according to a semi-static switching pattern (e.g., associated with a radio resource control (RRC) configuration). However, the second duration limits the time budget associated with the SDL band, which poses challenges because the SDL band is configured as an SCell. For example, an SCell is typically inactive when configured until a network node activates the SCell via an SCell activation command. After receiving the SCell activation command, the UE typically performs various operations in the SCell before the UE can communicate data using the SCell. For example, the UE may measure one or more synchronization signal blocks (SSBs), measure a channel quality indicator (CQI) associated with the SCell, and transmit a channel state information (CSI) report indicating the CQI associated with the SCell after receiving the SCell activation command and prior to transmitting or receiving data in the SCell. However, in some cases, the SCell activation timeline may exceed the semi-statically configured time budget associated with the SCell.

Various aspects relate generally to techniques associated with SCell activation in a switched carrier aggregation configuration, where the switched carrier aggregation configuration includes a PCell associated with an FDD band and an SCell associated with an SDL band. More particularly, a UE associated with the switched carrier aggregation configuration communicates only with the PCell or only the SCell in any given transmission time interval (TTI) according to an activation status associated with the SCell. For example, in some aspects, the UE may communicate only with the PCell, and does not spend any time in the SCell, prior to receiving an SCell activation command (e.g., while the SCell is inactive). In addition, the UE spends as much time as needed in the SCell to measure SSBs and monitor CQI after receiving an SCell activation command, regardless of any semi-statically configured switching pattern. Alternatively, a network node may configure multiple switching patterns, where the UE selects a first switching pattern to use during SCell activation (e.g., a switching pattern with a sufficient time budget to measure SSBs and monitor CQI), and selects a second switching pattern to use when the SCell is active. Additionally, or alternatively, in some aspects, the UE may interrupt communication with the PCell and communicate only with the SCell for one or more durations during SCell activation. Additionally, or alternatively, a network node may configure one or more on-demand SSBs in the SCell or may provide a CSI trigger via the PCell prior to a message acknowledging an SCell activation command, to ensure that the SCell activation timeline fits within the semi-statically configured time budget associated with the SCell.

Particular aspects of the subject matter described in this disclosure can be implemented to realize one or more of the following potential advantages. In some examples, the described techniques can be used to configure communication with a PCell associated with an FDD band and an SCell associated with an SDL band prior to, during, and after the SCell is activated. For example, the described techniques can be used to ensure that the UE is in communication with the PCell and able to receive one or more trigger messages associated with SCell activation, such as an aperiodic CSI-RS resource indication or a CSI report trigger, as the trigger messages are not expected or available via the SCell until the SCell is activated. In addition, the described techniques may enable the UE to communicate with the SCell during SCell activation for a time period that is sufficient to measure one or more SSBs and monitor CQI, such that the UE can transmit a CSI report to enable communication with the SCell. In this way, the described techniques can be used to activate an SCell associated with an SDL band in a switched carrier aggregation configuration, which may be useful in various scenarios such as providing an additional low band that a network node may utilize to reduce congestion and enable downlink communication in poor coverage areas despite overlapping with or having insufficient or excessive separation from uplink spectrum.

Some aspects described herein relate to a method of wireless communication performed by a UE. The method may include receiving, from a network node, a configuration for a PCell associated with an FDD carrier and an SCell associated with an SDL carrier. The method may include communicating with one or more of the PCell or the SCell based at least in part on an SCell activation status, wherein the communicating includes communicating only with the PCell or communicating only with the SCell in each TTI.

Some aspects described herein relate to a UE. The UE may include a processing system. The processing system may include one or more processors and one or more code-storing memories coupled with the one or more processors. The processing system may be configured to cause the UE to receive, from a network node, a configuration for a PCell associated with an FDD carrier and an SCell associated with an SDL carrier. The processing system may be configured to cause the UE to communicate with one or more of the PCell or the SCell based at least in part on an SCell activation status, wherein the communicating includes communicating only with the PCell or communicating only with the SCell in each TTI.

Some aspects described herein relate to a non-transitory computer-readable medium that stores a set of instructions for wireless communication by a UE. The set of instructions, when executed by one or more processors of the UE, may cause the UE to receive, from a network node, a configuration for a PCell associated with an FDD carrier and an SCell associated with an SDL carrier. The set of instructions, when executed by one or more processors of the UE, may cause the UE to communicate with one or more of the PCell or the SCell based at least in part on an SCell activation status, wherein the communicating includes communicating only with the PCell or communicating only with the SCell in each TTI.

Some aspects described herein relate to an apparatus for wireless communication. The apparatus may include means for receiving, from a network node, a configuration for a PCell associated with an FDD carrier and an SCell associated with an SDL carrier. The apparatus may include means for communicating with one or more of the PCell or the SCell based at least in part on an SCell activation status, wherein the communicating includes communicating only with the PCell or communicating only with the SCell in each TTI.

The systems, methods, and devices of this disclosure each have several innovative aspects, no single one of which is solely responsible for the desirable attributes disclosed herein.

Aspects of the present disclosure may generally be implemented by or as a method, apparatus, system, computer program product, non-transitory computer-readable medium, user equipment, network node, wireless communication device, or processing system as substantially described in the Detailed Description with reference to, and as illustrated by, the accompanying drawings. Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only some aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless communication network.

FIG. 2 is a diagram illustrating an example disaggregated network node architecture.

FIG. 3 is a diagram illustrating examples associated with switched supplemental downlink (SDL) carrier aggregation.

FIG. 4 is a diagram illustrating an example associated with a secondary cell (SCell) activation timeline.

FIG. 5 is a diagram illustrating an example associated with an expedited SCell activation timeline.

FIG. 6 is a diagram illustrating an example associated with switched SDL carrier aggregation prior to or during SCell activation.

FIG. 7 is a diagram illustrating an example associated with SDL carrier aggregation using different switching patterns prior to, during, or after SCell activation.

FIGS. 8A-8B are diagrams illustrating examples associated with interrupting communication in a frequency division duplexing (FDD) PCell to activate an SCell in a switched SDL carrier aggregation scenario.

FIG. 9 is a diagram illustrating an example associated with an on-demand synchronization signal block (SSB) to expedite SCell activation in a switched SDL carrier aggregation scenario.

FIG. 10 is a diagram illustrating an example associated with a channel state information (CSI) trigger in an FDD cell prior to a message acknowledging an SCell activation command in a switched SDL carrier aggregation scenario.

FIG. 11 is a diagram illustrating an example process performed, for example, at a UE or an apparatus of a UE, in accordance with the present disclosure.

FIG. 12 is a diagram of an example apparatus for wireless communication.

FIG. 13 is a diagram illustrating an example of a hardware implementation for an apparatus employing a processing system.

### DETAILED DESCRIPTION

5G New Radio (NR) may support enhanced mobile broadband (eMBB) access, Internet of Things (IoT) networks or reduced capability (RedCap) device deployments, ultra-reliable low-latency communication (URLLC) applications, or massive machine-type communication (mMTC), among other examples. To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial or aerial platforms, among other examples.

The methods, operations, apparatuses, and techniques described herein may enable one or more of the foregoing technologies or new technologies or support one or more of the foregoing use cases or new use cases.

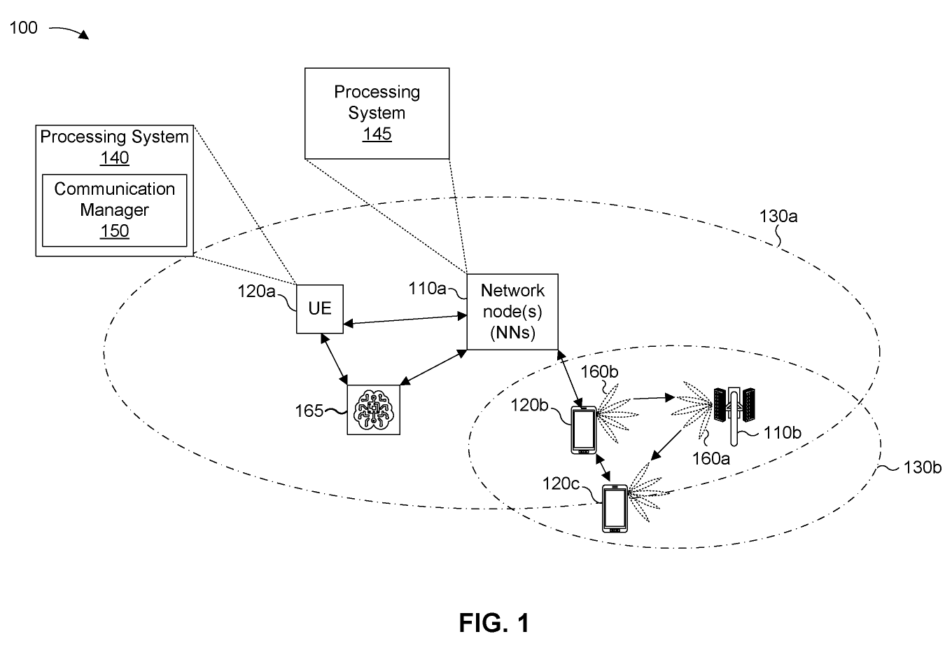

FIG. 1 is a diagram illustrating an example of a wireless communication network 100. The wireless communication network 100 may be or may include elements of a 5G network or a 6G network, among other examples. The wireless communication network 100 may include multiple network nodes 110. For example, in FIG. 1, the wireless communication network 100 includes multiple network nodes 110, including a network node 110a and a network node 110b (each of which also may be referred to herein simply as a “network node 110”). The network nodes 110 may support communications with multiple UEs 120. For example, in FIG. 1, the network nodes 110 support communication with a UE 120a, a UE 120b, and a UE 120c (each of which also may be referred to herein simply as a “UE 120”). In some examples, a UE 120 also may communicate with other UEs 120 and a network node 110 also may communicate with a core network and with other network nodes 110.

The network nodes 110 and the UEs 120 of the wireless communication network 100 communicate using the electromagnetic spectrum, which may be subdivided into various licensed or unlicensed operating bands, frequency ranges, component carriers, or channels that define associated frequencies available for communications. In some examples, each of the network nodes 110 and the UEs 120 may communicate using one or multiple component carriers in one or more operating bands or ranges. Typically, various operating bands are defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles.

A network node 110 or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system. As shown in FIG. 1, each UE 120 includes a processing system 140 and each network node 110 includes a processing system 145. A processing system (for example, the processing system 140 or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media, such as random-access memory, or read-only memory, or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors. One or more of the memories may individually or collectively store processor-executable code or instructions (such as software) (for example, which may be referred to as “one or more code-storing memories” or “code-storing memory circuitry”). For example, “code-storing memory” or “code-storing memory circuitry” refers to memory (or memory circuitry) that is configured to store processor-executable code or instructions. The processor-executable code or instructions, when executed by one or more of the processors, may configure one or more of the processors (or processing circuitry) to perform various functions or operations described herein. Additionally, or alternatively, in some examples, one or more of the processors may be configured to perform various functions or operations described herein without requiring configuration by software. Software shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 or the processing system 145 may include or implement one or more of the modems. The processing system 140 and the processing system 145 also may include or be coupled with multiple radios (collectively “the radio”), multiple RF chains, or multiple transceivers, each of which may in turn be coupled with one or more of multiple antennas. In some examples, one or more processors of the processing system 140 or the processing system 145 may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by the processing system 140 or by the processing system 145).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device, such as the network node 110 and the UE 120.

A network node 110 may be, may include, or also may be referred to as an NR network node, a 5G network node, a 6G network node, a Node B, a gNB, an access point (AP), a transmission reception point (TRP), a network entity, a network element, a network equipment, or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may include a single standalone base station or a single TRP that operates with a full radio protocol stack to enable or facilitate communication between a UE 120 and a core network of the wireless communication network 100.

Alternatively, and as also shown, a network node 110 may be a disaggregated network node 110 (sometimes referred to as a disaggregated base station), having a disaggregated architecture, meaning that the network node 110 may operate with a radio protocol stack that is physically distributed or logically distributed among two or more nodes in the same geographic location or in different geographic locations. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The disaggregated network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, or one or more RUs. In some examples, a CU, a DU, or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

In some examples, the wireless communication network 100 may be a heterogeneous network that includes network nodes 110 of various types. Different types of network nodes 110 may generally operate on the same or different operating bands, transmit at different power levels, or serve different coverage areas, each of which may be referred to as or associated with a particular cell 130 (for example, a cell 130a and a cell 130b).

The UEs 120 may be physically dispersed throughout the coverage area of the wireless communication network 100, and each UE 120 may be stationary or mobile. A UE 120 may be, may include, or also may be referred to as an access terminal, a mobile station, a client device, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), an artificially intelligent robot or other device implementing artificial intelligence, a UE function of a network node, or any other suitable device or function that may communicate in the wireless communication network 100.

Some UEs 120 may be classified according to different categories in association with different complexities or different capabilities. UEs 120 in a first category may be associated with relatively low complexity or cost such as NB-IoT devices or eMTC UEs. UEs 120 in a second category may include higher complexity or cost devices, such as mission-critical IoT devices, baseline UEs, high-tier UEs, advanced UEs, full-capability UEs, or premium UEs that are capable of URLLC, eMBB, or precise positioning in the wireless communication network 100. A third category of UEs 120 may have mid-tier complexity or capabilities (for example, capabilities between that of the UEs 120 of the first category and the UEs 120 of the second category). A UE 120 of the third category may be referred to as a reduced capability UE (“RedCap UE”), a mid-tier UE, an NR-Light UE, or an NR-Lite UE, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) or reconfigured (for example, in real-time or near-real-time) according to changing network conditions in the wireless communication network 100 or specific requirements of one or more UEs 120. An active BWP defines the operating bandwidth of the UE 120 within the operating bandwidth of the serving cell.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), or measurement information (for example, a layer 1 (L1)- reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120 or may transmit, to the UE 120, an indication of an MCS to be applied for an uplink signal.

A network node 110 or a UE 120 (such as by using the processing system 145 or the processing system 140, respectively, or one or more coupled modems) may perform signal processing on the information (such as filtering, amplification, modulation, digital-to-analog conversion, an IFFT operation, multiplexing, interleaving, mapping, or encoding, among other examples) to generate a processed signal in accordance with the selected MCS. In some examples, the network node 110 or the UE 120 (for example, using the processing system 145 or the processing system 140, respectively, or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 or one or more modems) may further perform spatial processing (for example, precoding) on the encoded information to generate one or more processed or precoded signals for downlink or uplink transmission, respectively. In some examples, the network node 110a or the UE 120a may perform codebook-based precoding or non-codebook-based precoding. Codebook-based precoding may involve selecting a precoder (for example, a precoding matrix) using a codebook. For example, the network node 110a may provide precoding information indicating which precoder, defined by the codebook, is to be used by the UE 120a. Non-codebook-based precoding may involve selecting or deriving a precoder based on, or otherwise associated with, one or more downlink or uplink signal measurements. The network node 110a or the UE 120a may transmit the processed downlink or uplink signals, respectively, via one or more antennas.

The network node 110a or the UE 120a may receive uplink signals or downlink signals, respectively, via one or more antennas. The network node 110a or the UE 120a (for example, using the processing system 145 or the processing system 140, respectively, or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, or decoding, among other examples), to map the received signal(s) to a sequence of binary bits (for example, received information) that estimates the information transmitted by the network node 110 or the UE 120 via the downlink or uplink signals. The network node 110a or the UE 120a (for example, using the processing system 145 or the processing system 140, respectively, or a coupled decoder or one or more modems) may decode the received information (such as by using an ECC, a decoding operation, or an FEC operation) to detect errors or correct bit errors in the received information to generate decoded information. The decoded information may estimate the information transmitted via the downlink or uplink signals.

In some examples, a UE 120 and a network node 110 may perform MIMO communication. MIMO communication generally refers to transmitting or receiving multiple signals (such as multiple layers or multiple data streams) simultaneously over the same time and frequency resources. A network node 110 or a UE 120 may communicate using single-user MIMO or multi-user MIMO (MU-MIMO), the latter of which being used by a network node 110 to simultaneously transmit signals to multiple UEs 120. MIMO techniques may involve spatial multiplexing (multi-layer transmission) or beamforming. To implement beamforming, the amplitudes or phases of signals transmitted via antenna elements may be modulated and shifted relative to each other (such as by manipulating a phase shift, a phase offset, or an amplitude) to generate one or more beams. For example, a network node 110 may generate one or more beams 160a, and a UE 120 may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with such a directional transmission or directional reception, a set of directional resources associated with a signal transmission or signal reception (for example, an angle of arrival, a horizontal direction, or a vertical direction), or a set of parameters or resources associated with one or more aspects of a directional signal, among other examples.

In some examples, a network node 110 or a UE 120 may implement massive MIMO, which may be associated with an increased (for example, “massive”) quantity of antennas at the network node 110 or at the UE 120, such as in a network implementing mmWave technology, which enables more precise beamforming or reduced interference. In some examples, the wireless communication network 100 may implement multi-TRP (mTRP) operation (including redundant transmission or reception on multiple TRPs) or non-coherent joint transmission (NC-JT).

The network node 110 and the UE 120 may establish a communication link or beam pair, and otherwise increase reliability, throughput, signal strength, or other signal properties for MIMO communications, by performing beam management operations, such as an initial beam acquisition operation, a beam refinement operation, or a beam recovery operation. For example, an initial beam acquisition operation may involve the network node 110 transmitting signals (for example, SSBs or other signals) via respective beams (for example, of the beams 160 of the network node 110) and the UE 120 receiving and measuring the signal(s) via respective beams of multiple beams (for example, from the beams 160 of the UE 120) to identify a best beam (or beam pair) for communication between the UE 120 and the network node 110. A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified or defined via one or more spatial parameters, such as a transmission configuration indicator (TCI) state or a quasi co-location (QCL) parameter, among other examples.

Some aspects and techniques as described herein may be implemented, at least in part, using an artificial intelligence (AI) program (for example, referred to herein as an “AI/ML model”), such as a program that includes a machine learning (ML) model or an artificial neural network (ANN) model. The AI/ML model may be deployed at one or more devices 165 (for example, one or more network nodes 110, one or more UEs 120, one or more servers, or one or more components of a cloud computing network, among other examples). For example, in a deployment in which AI/ML functionality is performed independently at a device 165, sometimes referred to as “overlay AI/ML,” the AI/ML model (or an instance or portion of the AI/ML model) may be deployed at a UE 120 (for example, by the processing system 140), a network node 110 (for example, by the processing system 145), one or more servers, or one or more components of a cloud computing network, among other examples. Additionally, or alternatively, in a deployment where AI/ML functionality is coordinated between different devices 165, sometimes referred to as “coordinated AI/ML,” or performed at all device and network layers, sometimes referred to as “native AI/ML,” the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, or efficient use of network bandwidth, or to reduce latency, among other examples). For example, the AI/ML model(s) may be trained to identify patterns or relationships in data corresponding to the wireless communication network 100, a device, or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases, such as a self-organizing network (SON), minimization of drive test (MDT), quality of experience (QoE), positioning, sensing, predictive mobility, or traffic prediction, among other examples. In some examples, AI-as-a-Service use cases may include measurement collection reporting by a UE 120, device selection criteria (for example, according to a geographical area where measurements are to be collected or UE capabilities to be used to collected measurements), or reporting configurations (for example, reporting parameters such as location, time, or sensor information, among other examples). Additionally, or alternatively, the AI/ML model(s) may enable AI/ML procedures (for example, RAN-triggered service establishment, configuration, inferencing using UE-side or network-side models, performance monitoring or management, or capability signaling, among other examples). Additionally, or alternatively, the AI/ML model(s) may enable RAN-based AI/ML services via one or more application program interfaces (APIs) or management interfaces for use cases, such as beam management, radio resource monitoring (RRM) relaxation, mobility prediction, load prediction, network energy savings, or coverage and capacity improvements, among other examples).

In some aspects, the UE 120 may include a communication manager 150. As described in more detail elsewhere herein, the communication manager 150 may receive, from a network node 110, a configuration for a primary cell (PCell) associated with a frequency division duplexing (FDD) carrier and a secondary (SCell) associated with a supplemental downlink (SDL) carrier; and communicate with one or more of the PCell or the SCell based at least in part on an SCell activation status, wherein the communicating includes communicating only with the PCell or communicating only with the SCell in each TTI. Additionally, or alternatively, the communication manager 150 may perform one or more other operations described herein.

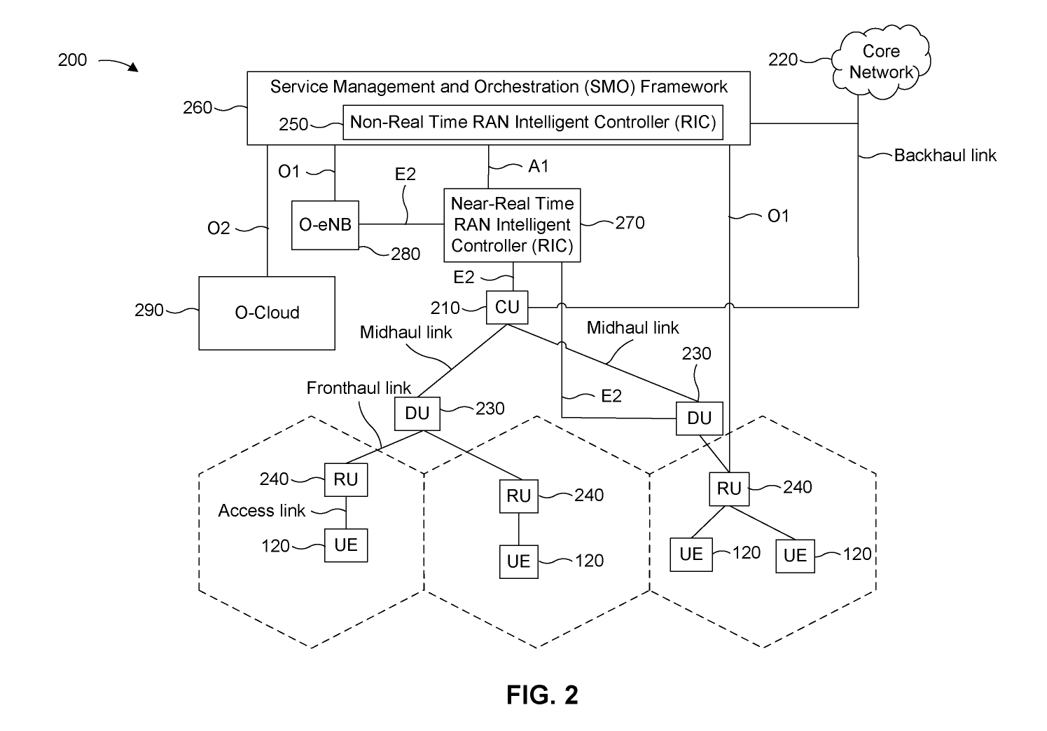

FIG. 2 is a diagram illustrating an example disaggregated network node architecture 200. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for transmitting or receiving signals, such as data, control information, or reference signals via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, or a Near-RT RIC 270. In some aspects, the SMO Framework 260 may communicate with a hardware aspect of a 4G RAN, a 5G NR RAN, or a 6G RAN, such as an open eNB (O-eNB) 280, via an O1 interface. Additionally, or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, or policy-based guidance of applications or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

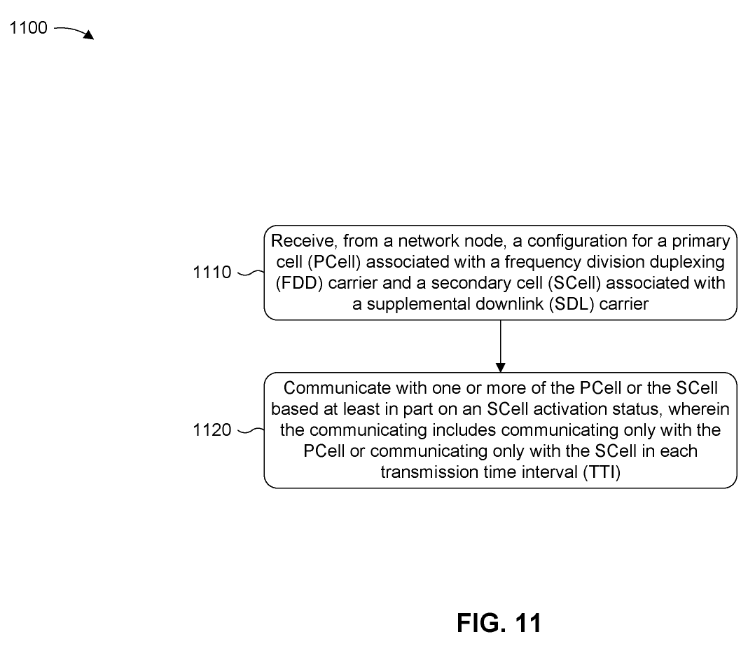

The network node 110, the processing system 145 of the network node 110, the UE 120, the processing system 140 of the UE 120, the CU 210, the DU 230, the RU 240, or any other component(s) of FIGS. 1 or 2 may implement one or more techniques or perform one or more operations associated with SCell activation for switched SDL carrier aggregation, as described in more detail elsewhere herein. For example, the processing system 145 of the network node 110, the processing system 140 of the UE 120, the CU 210, the DU 230, or the RU 240 may perform or direct operations of, for example, process 1100 of FIG. 11 or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 1100 of FIG. 11 or other processes as described herein. In some examples, executing instructions may include running the instructions, converting the instructions, compiling the instructions, or interpreting the instructions, among other examples.

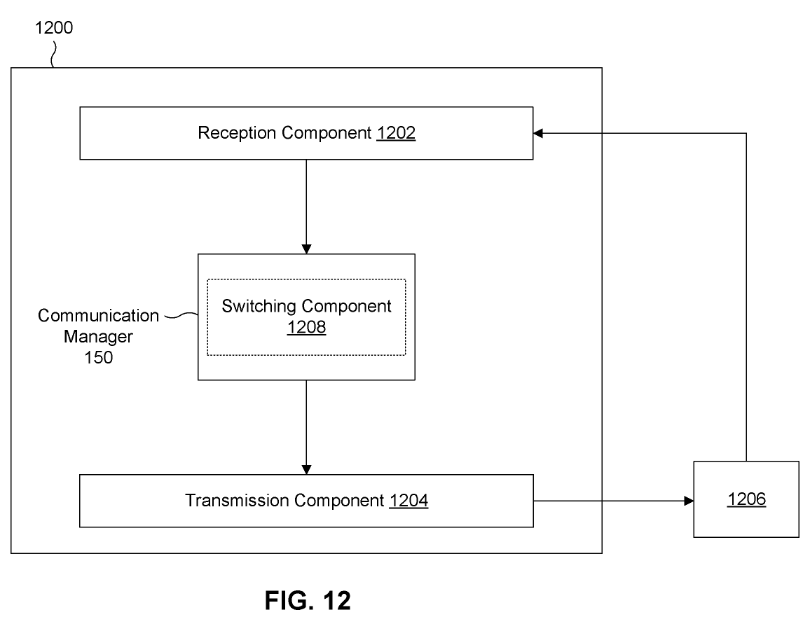

In some aspects, the UE 120 includes means for receiving, from a network node 110, a configuration for a PCell associated with an FDD carrier and an SCell associated with an SDL carrier; and/or means for communicating with one or more of the PCell or the SCell based at least in part on an SCell activation status, wherein the communicating includes communicating only with the PCell or communicating only with the SCell in each TTI. The means for the UE 120 to perform operations described herein may include, for example, one or more of communication manager 150, processing system 140, a radio, one or more RF chains, one or more transceivers, one or more antennas, one or more modems, a reception component (for example, reception component 1202 depicted and described in connection with FIG. 12), or a transmission component (for example, transmission component 1204 depicted and described in connection with FIG. 12), among other examples.

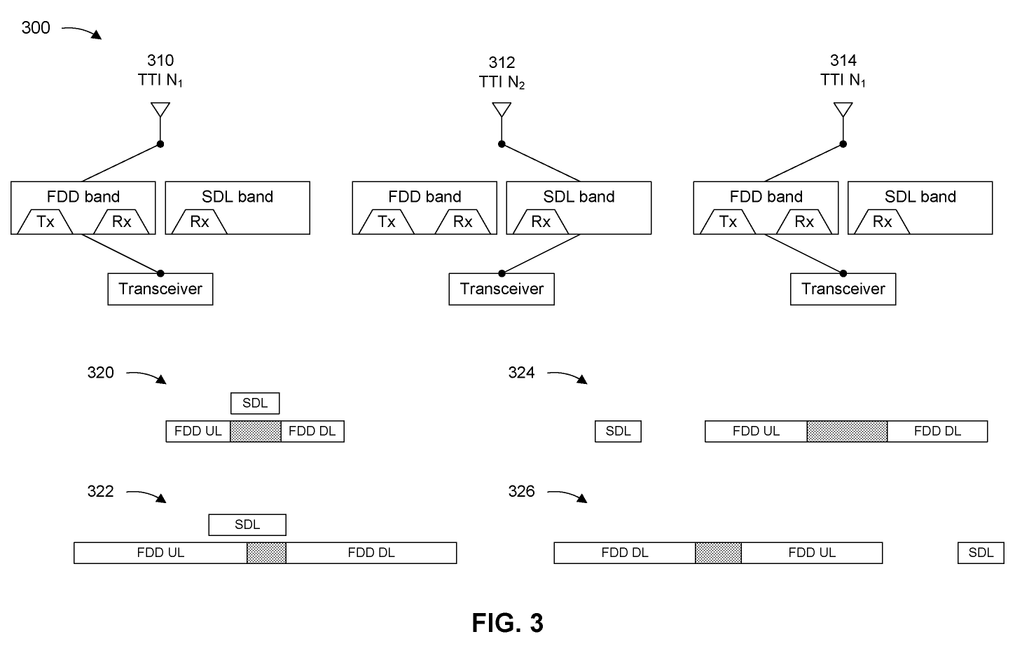

FIG. 3 is a diagram illustrating examples 300 associated with switched SDL carrier aggregation. In a typical or traditional carrier aggregation configuration, multiple carriers are combined into a single channel to enhance data capacity. For example, unpaired spectrum or an FDD band that includes an uplink carrier and a downlink carrier may be combined with an SDL carrier such that downlink data can be simultaneously transmitted to a single UE 120 on multiple downlink carriers. In this way, the SDL carrier may be utilized to enhance downlink capacity and significantly increase downlink speed and throughput. However, there are various scenarios where switching between an FDD band and an SDL carrier (e.g., using only the FDD band or the SDL carrier at any given time) may be useful. For example, mid-band spectrum is most effective closer to a cell site, while low-band spectrum tends to propagate farther distances and is therefore useful at greater distances from cell sites. However, low-band spectrum often carries significant traffic volumes in urban (indoor) and rural areas, which may lead to congestion that severely degrades user experience. Although using a low-band SDL carrier with the ability to reach most poor coverage areas could potentially improve low-band performance, many low-band SDL carriers cannot be paired with a primary carrier that supports uplink communication. For example, some SDL carriers may fall within downlink and uplink spectrum associated with an FDD carrier (e.g., within a duplex gap or guard band), overlap with uplink spectrum, or have an insufficient or excessive separation from uplink spectrum.

Accordingly, as shown in FIG. 3, a carrier aggregation configuration may utilize switching, where a UE 120 switches between communicating exclusively with a PCell associated with an FDD band that includes a downlink carrier and an uplink carrier, and communicating exclusively with an SCell associated with an SDL band. For example, a UE 120 that supports inter-carrier scheduling may monitor the downlink carrier associated with the PCell for DCI, which may schedule downlink transmissions via the SDL band in addition to the downlink carrier associated with the PCell. The UE 120 may switch from communicating only with the PCell to communicating only with the SCell for a scheduled transmission interval, and may switch back to communicating with the PCell after the scheduled transmission interval in the SDL carrier. For example, a network node 110 may provide the UE 120 with a semi-static switching pattern (e.g., associated with an RRC configuration) that indicates a first duration, denoted N ₁, for communicating only with the PCell, and a second duration, denoted N ₂, for communicating only with the SCell, where N ₁ and N ₂ may be measured in units of slots, frames, absolute time periods (e.g., in milliseconds), or other suitable TTIs.

Accordingly, as shown in FIG. 3, the UE 120 may communicate only with the PCell associated with the FDD band for the first duration at 310, and the UE 120 may switch to communicating only with the SCell associated with the SDL band for the second duration at 312. The switching pattern may then repeat, with the UE 120 switching back to communicating only with the PCell for the first duration at 314, and switching again to communicating only with the SCell for the second duration (not shown in FIG. 3). As described herein, the switched carrier aggregation configuration may be useful in various scenarios such as providing an additional low band that a network node 110 may utilize to reduce congestion and enable downlink communication in poor coverage areas, despite overlapping with or having insufficient or excessive separation from uplink spectrum.

For example, in a first scenario 320, an FDD band includes an uplink carrier and a downlink carrier separated by a guard band (also known as a duplexing gap), and an SDL carrier falls within the guard band. In the first scenario 320, a filter stopband between the SDL carrier and the uplink carrier in the FDD band may be insufficient to prevent self-interference (where transmission via the uplink carrier interferes with reception via the SDL carrier), which makes traditional carrier aggregation infeasible. Similarly, in a second scenario 322, the SDL carrier overlaps with the uplink carrier in the FDD band, making traditional carrier aggregation infeasible due to potential self-interference. Alternatively, in a third scenario 324 and a fourth scenario 326, the SDL carrier has a large separation from the FDD band, such that aggregation via a single antenna poses challenges with respect to optimizing radiated performance in both the FDD band and the SDL carrier. Furthermore, using additional antenna elements to support combining the SDL carrier with the FDD band results in increased costs and RF architecture complexity (e.g., a form factor with additional components and volume).

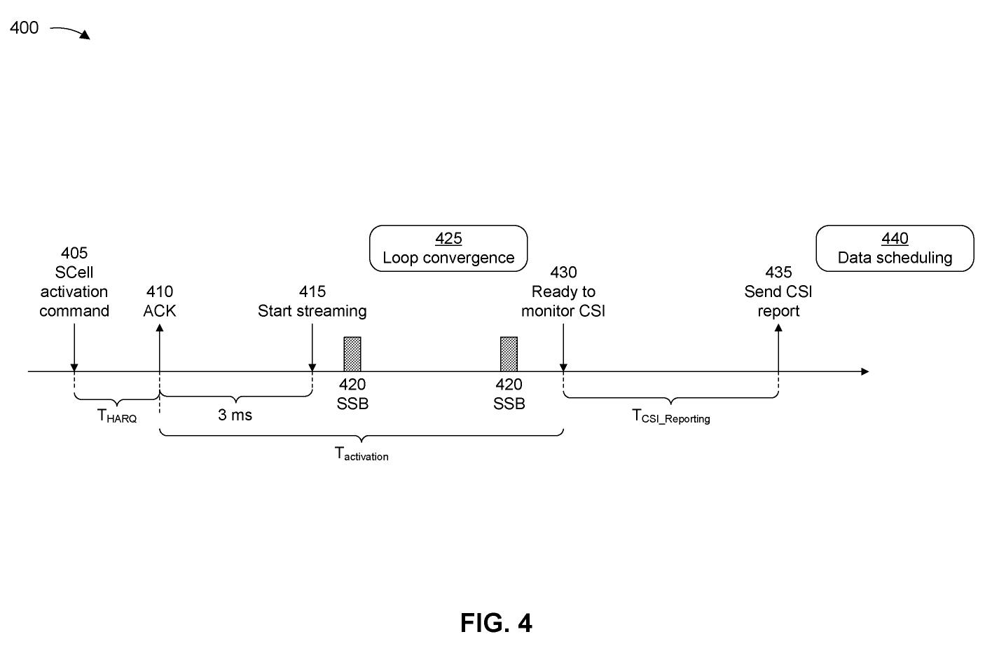

FIG. 4 is a diagram illustrating an example 400 associated with an SCell activation timeline. As described herein, in a switched carrier aggregation, a UE 120 can switch between communicating only with a PCell associated with an FDD band for a first duration and communicating only with an SCell associated with an SDL band for a second duration according to a semi-static (e.g., RRC-configured) switching pattern. Accordingly, switched carrier aggregation may be enabled to reduce congestion or improve performance in poor coverage areas in scenarios where an SDL carrier is adjacent to or overlaps with an FDD uplink carrier or where an SDL carrier has a large separation from the FDD band. However, in a switched carrier aggregation configuration, the second duration (for the SDL band) limits the time budget associated with the SDL band, which poses challenges because the SDL band is configured as an SCell. For example, referring to FIG. 4, an SCell is inactive when configured and remains inactive until a network node 110 activates the SCell via an SCell activation command 405, which may be an RRC command, a MAC-CE command, or another suitable command. After receiving the SCell activation command 405, the UE 120 typically performs various operations before communicating data using the SCell.

For example, after receiving the SCell activation command 405, the UE 120 may transmit an acknowledgement (ACK) message 410 associated with the SCell activation command 405, where a duration between the SCell activation command 405 and the ACK message 410 is denoted T_{HARQ}. As further shown in FIG. 4, the UE 120 then waits a fixed duration (e.g., 3 milliseconds), and at 415 streaming starts and the UE 120 measures one or more SSBs 420 (e.g., where the number of SSBs 420 that are measured may depend on whether the UE 120 was measuring SSBs 420 from the SCell prior to receiving the SCell activation command 405). After measuring the one or more SSBs 420, the UE 120 performs loop convergence at 425 to update a transceiver loop to receive other signals from the SCell, and is ready to monitor CSI at 430. As shown in FIG. 4, the SCell is activated at the time when the UE 120 is ready to monitor CSI, where a duration between the ACK message 410 and the time when the UE 120 is ready to monitor CSI is denoted T_{activation} and the total time from the SCell activation command 405 to the time when the UE 120 is ready to monitor CSI is T_{HARQ} + T_{activation}. However, before the UE 120 can start to transmit or receive data via the SCell, the UE 120 performs CSI monitoring (e.g., monitoring and measuring one or more CSI-RS transmissions) to determine a CQI associated with the SCell, and transmits a CSI report indicating the CQI associated with the SCell at 435, where a duration between the time when the UE 120 is ready to monitor CSI and the time when the UE 120 transmits the CSI report is denoted T_{CSI_reporting}. As shown, at 440, the UE 120 can then be scheduled to transmit or receive data via the SCell.

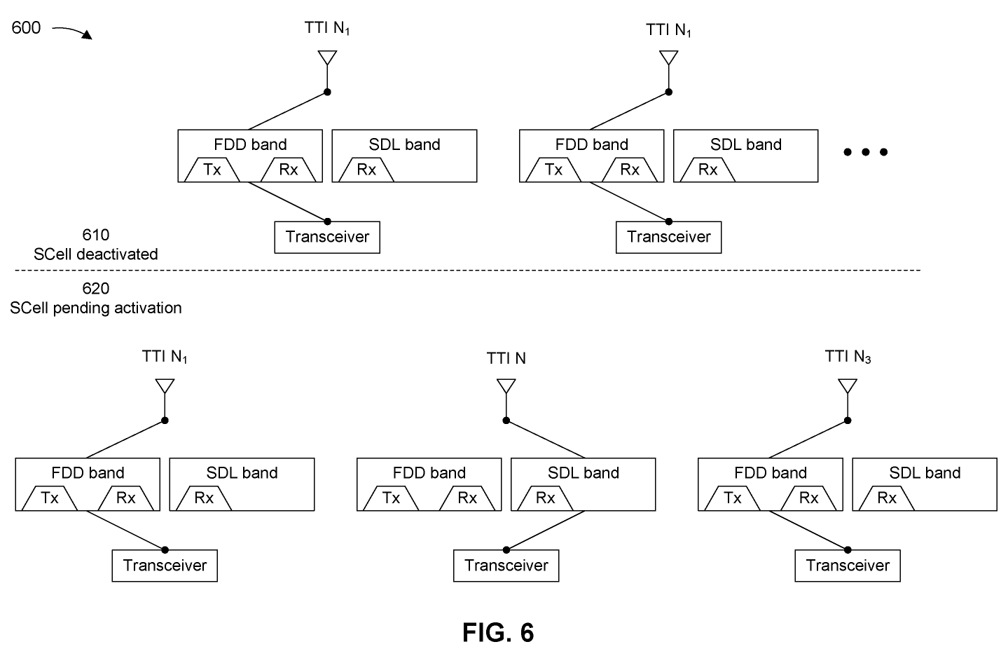

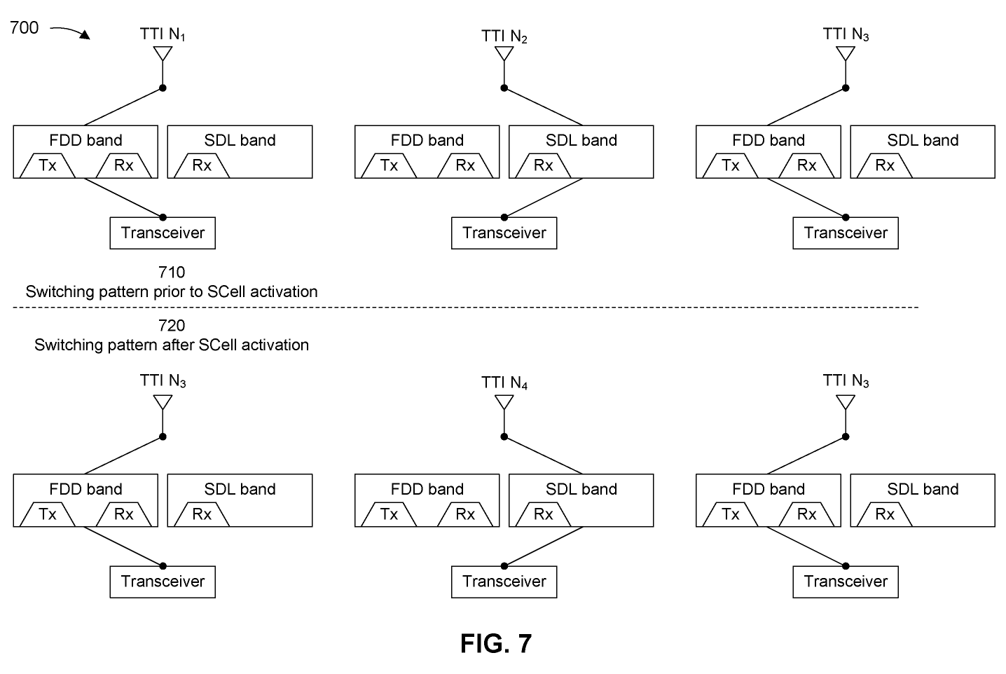

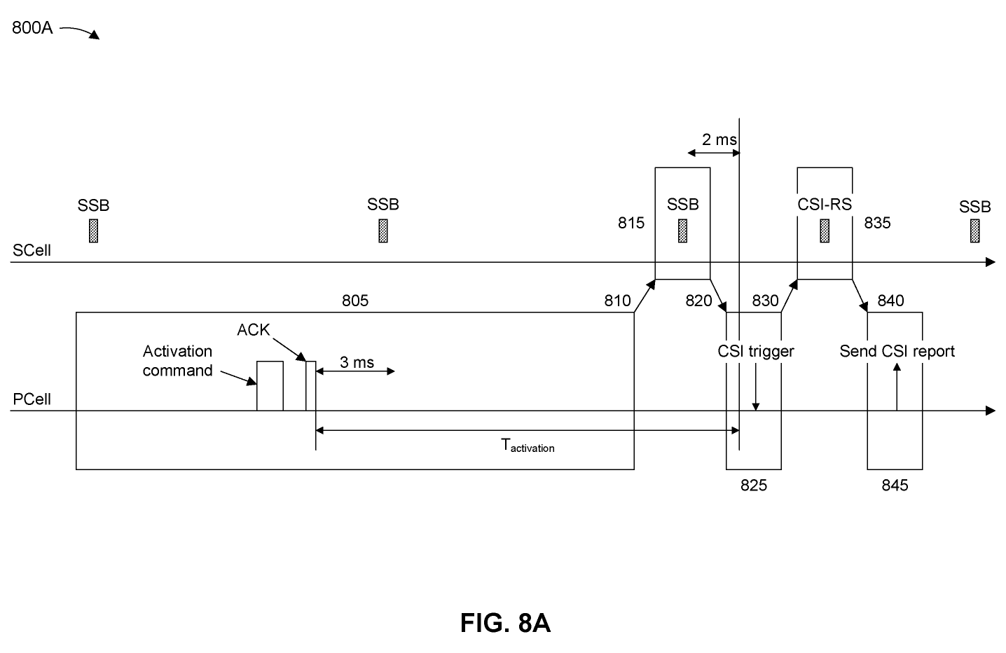

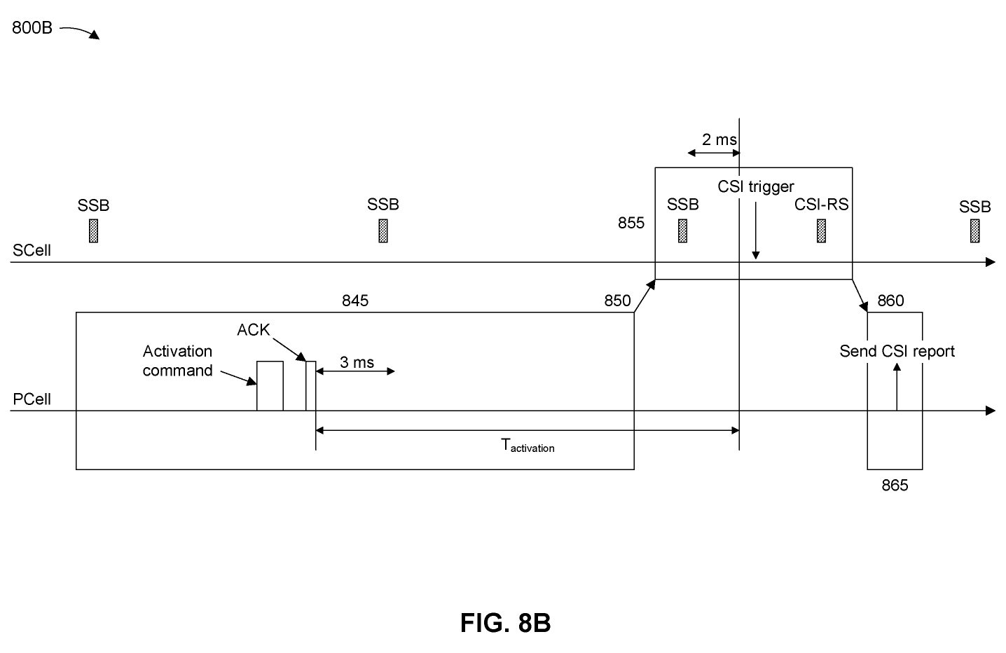

As shown in FIG. 4, the total SCell activation time, starting from when the SCell activation command 405 is received until the UE 120 is ready to transmit or receive data via the SCell, may be denoted T_{HARQ} + T_{activation} + T_{CSI_reporting}. In some cases, the SCell activation timeline may exceed the semi-statically configured time budget for an SCell associated with an SDL carrier in a switched carrier aggregation configuration. Accordingly, various aspects relate generally to techniques associated with SCell activation in a switched carrier aggregation configuration. Further details are provided herein with respect to FIG. 6, FIG. 7, FIGS. 8A-8B, FIG. 9, and FIG. 10.

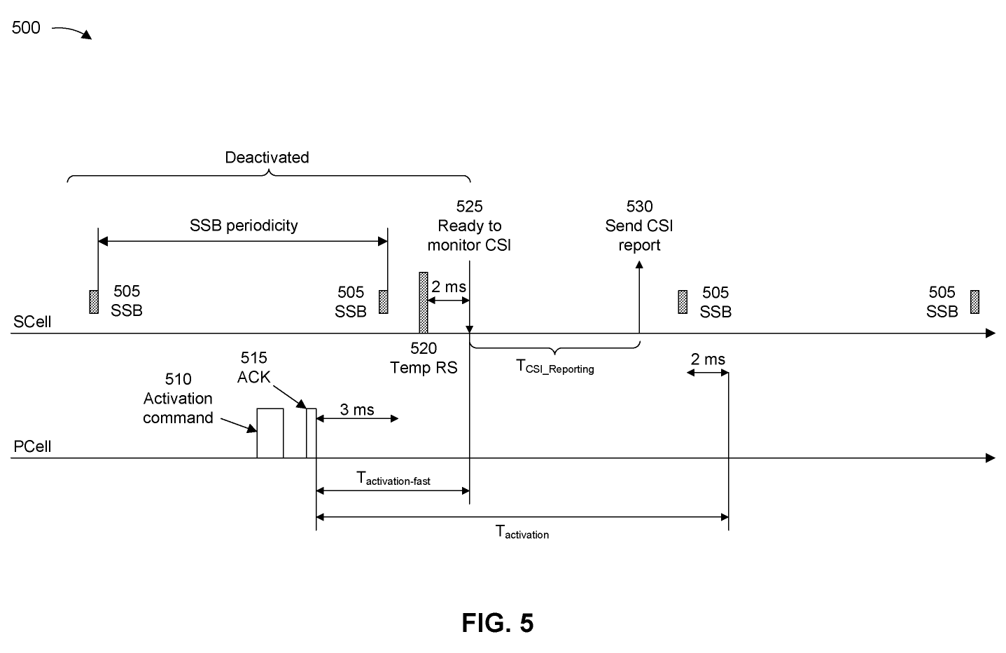

FIG. 5 is a diagram illustrating an example 500 associated with an expedited SCell activation timeline. As shown in FIG. 5, the expedited SCell activation timeline is much shorter than the SCell activation timeline shown in FIG. 4. For example, as shown in FIG. 5, a UE 120 may monitor and measure SSBs 505 transmitted by the SCell with a fixed periodicity while the SCell is deactivated. The SCell remains inactive until a network node 110 activates the SCell via an SCell activation command 510, which may be an RRC command, a MAC-CE command, or another suitable command. After the SCell activation command 510, the UE 120 may transmit an ACK message 515 associated with the SCell activation command 510. As further shown in FIG. 5, the network node 110 may trigger or otherwise schedule a temporary reference signal 520 (e.g., an aperiodic tracking reference signal (TRS)) in the SCell pending activation. Accordingly, after transmitting the ACK message 515, the UE 120 waits a fixed duration (e.g., 3 milliseconds) and then measures the temporary reference signal 520 for automatic gain control (AGC) and time/frequency tracking. As shown in FIG. 5, the SCell is activated at a time 525 when the UE 120 is ready to monitor CSI, which is a fixed duration (e.g., 2 milliseconds) after the temporary reference signal 520. As shown, the expedited activation time from the ACK message 515 is denoted T_{activation-fast}, which is much shorter than the SCell activation time T_{activation}, due to the temporary reference signal 520 enabling operations that would otherwise depend on the UE 120 measuring one or more SSBs 505 after transmitting the ACK message 515.

However, similar to SCell activation without the temporary reference signal 520, the UE 120 performs CSI monitoring (e.g., monitoring and measuring one or more CSI-RS transmissions) to determine a CQI associated with the SCell, and transmits a CSI report indicating the CQI associated with the SCell at 530, before the UE 120 can start to transmit or receive data via the SCell. Accordingly, the total SCell activation time, starting from when the SCell activation command 510 is received until the UE 120 is ready to transmit or receive data via the SCell, may still exceed the semi-statically configured time budget for an SCell associated with an SDL carrier in a switched carrier aggregation configuration. Accordingly, various aspects relate to techniques associated with SCell activation in a switched carrier aggregation configuration, as described herein with respect to FIGS. 6 ,7, 8A-8B, 9 and 10.

FIG. 6 is a diagram illustrating an example 600 associated with switched SDL carrier aggregation prior to or during SCell activation. As described herein, in a switched carrier aggregation configuration, a network node 110 may transmit, and a UE 120 may receive, configuration information for a PCell associated with an FDD band that includes an uplink carrier for uplink reception and a downlink carrier for downlink reception, and configuration information for an SCell associated with an SDL band or SDL carrier. In addition, the network node 110 may transmit, and the UE 120 may receive, a semi-static (e.g., RRC-configured) switching pattern that indicates a first duration, N ₁, in which the UE 120 communicates only with the PCell and a second duration, N ₂, in which the UE 120 communicates only with the SCell. Accordingly, the UE 120 may switch between communicating only with the PCell for N ₁ TTIs and communicating only with the SCell for N ₂ TTIs based on the switching pattern.

In some aspects, the UE 120 may disregard the semi-static switching pattern for the PCell and the SCell prior to SCell activation. For example, as shown at 610, the UE 120 may disregard the semi-static switching pattern and communicate only with the PCell when the SCell is deactivated. For example, when the SCell is deactivated and no SCell activation command has been received, the UE 120 has no operations to perform in the SCell. Accordingly, the UE 120 spends no time in the inactive SCell and communicates with the PCell in all TTIs while the SCell is deactivated.

Additionally, or alternatively, the UE 120 may disregard the semi-static switching pattern for the PCell and the SCell during SCell activation. For example, as shown at 620, the UE 120 may disregard the semi-static switching pattern after receiving an SCell activation command, and may spend as much time as needed in the SCell that is pending activation to measure one or more SSBs and perform CQI monitoring. For example, the UE 120 may receive an SCell activation command while communicating with the PCell for a duration of N ₁ TTIs, and may then switch to the SCell for N TTIs after receiving the SCell activation command, where N has a value such that N TTIs satisfies (e.g., equals or exceeds) a total time to measure one or more SSBs, activate the SCell, and monitor CQI in the SCell associated with the SDL carrier. In general, N is independent from (and potentially larger than) the N ₂ value associated with the semi-static switching pattern and corresponding to the RRC-configured time budget for the SCell. Accordingly, after spending N TTIs in the SCell, the UE 120 may switch back to the PCell and transmit a CSI report indicating the CQI associated with the SCell (because the SCell is an SDL carrier and has no corresponding uplink carrier). The UE 120 may then follow the semi-static switching pattern while the SCell is active.

FIG. 7 is a diagram illustrating an example 700 associated with SDL carrier aggregation using different switching patterns prior to, during, or after SCell activation. As described herein, in a switched carrier aggregation configuration, a network node 110 may transmit, and a UE 120 may receive, configuration information for a PCell associated with an FDD band that includes an uplink carrier and a downlink carrier, and configuration information for an SCell associated with an SDL band or SDL carrier. In addition, the network node 110 may transmit, and the UE 120 may receive, multiple semi-static (e.g., RRC-configured) switching patterns that each indicate a first duration, N ᵢ, in which the UE 120 communicates only with the PCell, and a second duration, N ᵢ₊₁, in which the UE 120 communicates only with the SCell.

In some aspects, the UE 120 may disregard the semi-static switching patterns for the PCell and the SCell prior to SCell activation. For example, when the SCell is deactivated and no SCell activation command has been received, the UE 120 spends no time in the inactive SCell and communicates with the PCell in all TTIs.

In some aspects, the UE 120 may select, from the multiple semi-static switching patterns, a first switching pattern to use during SCell activation and a second switching pattern to use after SCell activation, where the first switching pattern and the second switching pattern may have different N ᵢ values and/or different N ᵢ₊₁ values. Accordingly, as shown at 710, the UE 120 may apply the first switching pattern based on receiving an SCell activation command while communicating with the PCell, where the UE 120 may switch to the SCell after N₁ TTIs have elapsed in the PCell and then communicate with the SCell for N ₂ TTIs. In some aspects, N₂ may have a value that results in N ₂ TTIs satisfying (e.g., equaling or exceeding) a total time to measure one or more SSBs, activate the SCell, and monitor CQI in the SCell associated with the SDL carrier. As further shown, at 720, the UE 120 may apply the second switching pattern after the SCell has been activated and the UE 120 is ready to receive downlink data via the SCell. For example, in the second switching pattern, the UE 120 may switch between communicating with the PCell for N₃ TTIs and communicating with the SCell for N₄ TTIs, where N ₁ and N ₃ may have the same or different values and N ₂ and N₄ may have the same or different values. In some aspects, the UE 120 may then follow the second switching pattern while the SCell is active.

In some aspects, while the UE 120 is communicating with the SCell according to a particular switching pattern (e.g., the first switching pattern during SCell activation or the second switching pattern after SCell activation), cell-specific signals in the FDD band associated with the PCell may be invalidated. For example, the cell-specific signals that are invalidated in the FDD band may include SSBs, signals transmitted in RACH occasions, and signals transmitted in a PDCCH common search space, among other examples. For example, while the UE 120 is using the first switching pattern during SCell activation, cell-specific signals in the FDD band may be invalidated in N₂ TTIs out of every N ₁+ N ₂ TTIs. Similarly, while the UE 120 is using the second switching pattern after SCell activation, cell-specific signals in the FDD band may be invalidated in N₄ TTIs out of every N ₃+ N₄ TTIs.

FIGS. 8A-8B are diagrams illustrating examples 800A and 800B associated with interrupting communication in an FDD PCell to activate an SCell in a switched SDL carrier aggregation scenario. For example, as described herein, a network node 110 may configure one or more switching patterns for a UE 120 to switch between communicating only with the PCell for N ᵢ TTIs and communicating only with the SCell for N ᵢ₊₁ TTIs. In some aspects, the UE 120 may disregard any semi-static switching patterns for the PCell and the SCell prior to and during SCell activation. For example, when the SCell is deactivated and no SCell activation command has been received, the UE 120 has no operations to perform in the SCell. Accordingly, the UE 120 spends no time in the inactive SCell and communicates with the PCell in all TTIs while the SCell is deactivated. In addition, after receiving an SCell activation command, the UE 120 may disregard the semi-static switching patterns and remain within the PCell, except to switch to the SCell to measure one or more SSBs and receive one or more CSI-RS transmissions to generate CQI for the SCell.

In particular, as described herein, the UE 120 may interrupt communication in the PCell for one or more durations, causing a scheduling restriction in the PCell, where the one or more durations may be based on an SSB duration in the SCell, an SSB measurement timing configuration (SMTC) duration in the SCell, a CSI trigger duration in the PCell or the SCell, a CSI-RS duration in the SCell, or a bidirectional switching time between the PCell and the SCell (e.g., where the bidirectional switching time may be a UE capability, with the UE 120 indicating a supported switching time from multiple candidate switching times). Furthermore, in some aspects, the network node 110 may indicate to the UE 120 whether to remain in the SCell associated with the SDL carrier during SCell activation, or to remain in the PCell and interrupt communication in the PCell for the one or more durations, as described herein.

For example, as shown in FIG. 8A, the UE 120 may be communicating with the PCell when an SCell activation command is received (e.g., while the SCell is deactivated), and may continue to communicate only with the SCell after transmitting an ACK message associated with the SCell activation command. For example, after transmitting the ACK message and waiting a fixed duration associated with the ACK message, the UE 120 may remain in the PCell for a first duration 805, which may last until a time 810 that is just prior to a next SSB in the SCell. For example, the time 810 may be related to a switching time associated with switching a transceiver from the FDD band associated with the PCell to the SDL carrier associated with the SCell. Accordingly, at time 810, the UE 120 may interrupt communication with the PCell (e.g., in both the downlink carrier and the uplink carrier of the FDD band), switch to the SCell, and communicate only with the SCell for a duration 815 in which the UE 120 measures one or more SSBs in the SCell. In some aspects, in cases where the UE 120 has multiple SSBs to measure in the SCell, the UE 120 may switch back to the PCell between SSB receptions and corresponding SSB measurements or remain in the SCell between SSB receptions and corresponding SSB measurements.

As shown, at a time 820, the UE 120 may switch back to the PCell and resume communicating only with the PCell for a duration 825. For example, the time 820 may be related to a switching time associated with switching the transceiver from the SDL carrier associated with the SCell to the FDD band associated with the PCell. While communicating with the PCell for the duration 825, the UE 120 may receive a CSI trigger that indicates an aperiodic CSI-RS resource for the SCell. Accordingly, at time 830, the UE 120 may again interrupt communication with the PCell (e.g., in both the downlink carrier and the uplink carrier of the FDD band), switch to the SCell, and communicate only with the SCell for a duration 835 in which the UE 120 measures one or more CSI-RS transmissions in the SCell. As shown, at a time 840, the UE 120 may switch back to the PCell and resume communicating only with the PCell for a duration 845 in which the UE 120 transmits a CSI report that indicates a CQI associated with the SCell based on the CSI-RS transmissions measured in the SCell. In some aspects, the UE 120 may then follow the semi-static switching pattern for the PCell and the SCell.

Alternatively, as shown in FIG. 8B, the UE 120 may be communicating with the PCell when an SCell activation command is received (e.g., while the SCell is deactivated), and may continue to communicate only with the SCell after transmitting an ACK message associated with the SCell activation command. For example, after transmitting the ACK message and waiting a fixed duration associated with the ACK message, the UE 120 may remain in the PCell for a first duration 845, which may last until a time 850 that is just prior to a next SSB in the SCell. For example, the time 850 may be related to the switching time associated with switching a transceiver from the FDD band associated with the PCell to the SDL carrier associated with the SCell. Accordingly, at time 850, the UE 120 may interrupt communication with the PCell (e.g., in both the downlink carrier and the uplink carrier of the FDD band), switch to the SCell, and communicate only with the SCell for a duration 855 in which the UE 120 measures one or more SSBs in the SCell, receives a CSI trigger in the SCell that indicates an aperiodic CSI-RS resource for the SCell, and measures one or more CSI-RS transmissions in the SCell. In some aspects, in cases where the UE 120 has multiple SSBs to measure in the SCell, the UE 120 may switch back to the PCell between SSB receptions and corresponding SSB measurements or remain in the SCell between SSB receptions and corresponding SSB measurements. As shown, at a time 860, the UE 120 may switch back to the PCell and resume communicating only with the PCell for a duration 865 in which the UE 120 transmits a CSI report that indicates a CQI associated with the SCell based on the CSI-RS transmissions measured in the SCell. In some aspects, the UE 120 may then follow the semi-static switching pattern for the PCell and the SCell.

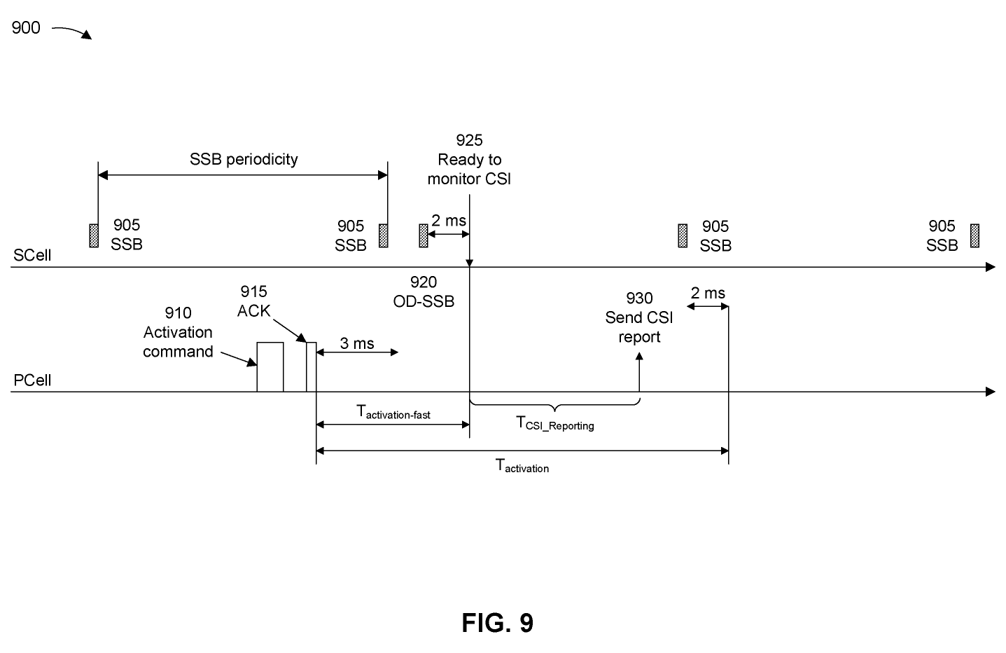

FIG. 9 is a diagram illustrating an example 900 associated with an on-demand SSB to expedite SCell activation in a switched SDL carrier aggregation scenario. For example, as shown in FIG. 9, a UE 120 may monitor and measure SSBs 905 transmitted by the SCell with a fixed periodicity while the SCell is deactivated. The SCell remains inactive until a network node 110 activates the SCell via an SCell activation command 910, which may be an RRC command, a MAC-CE command, or another suitable command. After the SCell activation command 910, the UE 120 may transmit an ACK message 915 associated with the SCell activation command 910. As further shown, the network node 110 may trigger or otherwise schedule an on-demand SSB 920 in the SCell that is pending activation. For example, in some aspects, the on-demand SSB 920 may be scheduled such that a total SCell activation timeline, starting from transmission of the ACK message 915 until the UE 120 has measured CQI for the SCell, does not exceed a time budget configured in a semi-static switching pattern for the PCell. For example, after transmitting the ACK message 915, the UE 120 waits a fixed duration (e.g., 3 milliseconds) and then measures the on-demand SSB 920. As shown in FIG. 9, the SCell is activated at a time 925 when the UE 120 is ready to monitor CSI, which is a fixed duration (e.g., 2 milliseconds) after the on-demand SSB 920. The UE 120 then performs CSI monitoring (e.g., monitoring and measuring one or more CSI-RS transmissions) to determine a CQI associated with the SCell, and returns to the PCell to transmit a CSI report indicating the CQI associated with the SCell at 930.

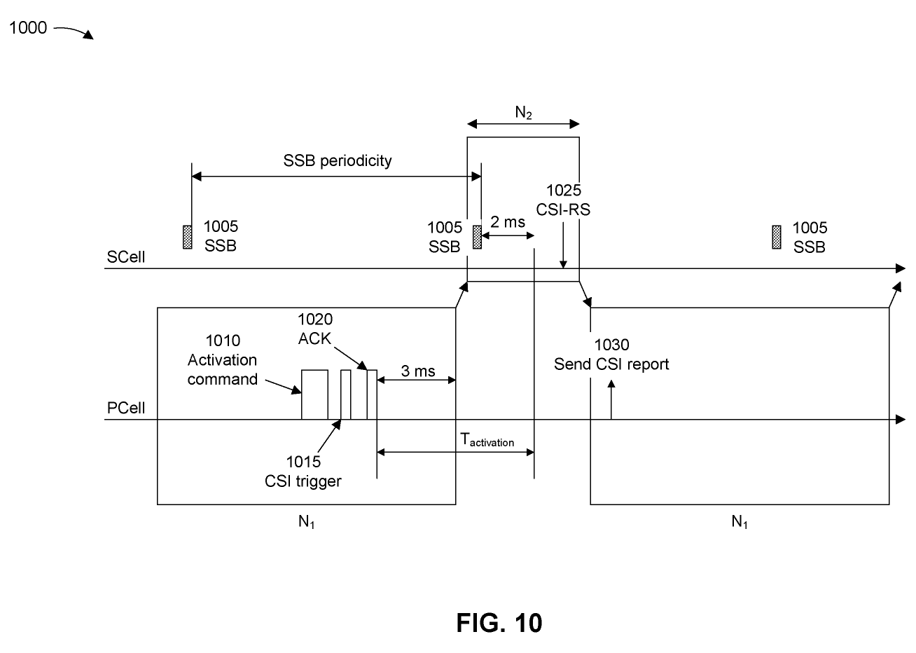

FIG. 10 is a diagram illustrating an example 1000 associated with a CSI trigger in an FDD cell prior to a message acknowledging an SCell activation command in a switched SDL carrier aggregation scenario. For example, as shown in FIG. 10, a UE 120 may communicate with a PCell associated with an FDD band while an SCell associated with an SDL carrier is inactive. The SCell remains inactive until a network node 110 activates the SCell via an SCell activation command 1010, which may be an RRC command, a MAC-CE command, or another suitable command. After the SCell activation command 1010, the network node 110 may transmit a CSI trigger 1015 via the PCell, and before the UE 120 transmits an ACK message 1020 associated with the SCell activation command 1010. For example, in some aspects, the CSI trigger 1015 may configure CSI-RS resources in the SCell that immediately or closely follow an adjacent resource associated with a periodic SSB 1005 that the UE 120 measures in connection with SCell activation. Accordingly, after transmitting the ACK message 1020 and waiting a fixed duration, the UE 120 may switch to the SCell, measure an SSB 1005 and measure a CSI-RS 1025 associated with the CSI-RS resources configured in the CSI trigger 1015. The UE 120 may then resume communication with the PCell to transmit a CSI report 1030 indicating a CQI based on the CSI-RS 1025 measured in the SCell. In this way, the network node 110 may configure a semi-static switching pattern for the PCell and the SCell, and may send one or more messages (e.g., the SCell activation command 1010 and the CSI trigger 1015) and configure various resources (e.g., for the SSBs 1005 and CSI-RS 1025 in the SCell, and the CSI report 1030 in the PCell) according to a timing that ensures that all operations associated with activating the SCell can be completed within the time budget that the semi-static switching pattern indicates for the SCell.

FIG. 11 is a diagram illustrating an example process 1100 performed, for example, at a UE or an apparatus of a UE, in accordance with the present disclosure. Example process 1100 is an example where the apparatus or the UE (e.g., UE 120) performs operations associated with SCell activation for switched SDL carrier aggregation.

As shown in FIG. 11, in some aspects, process 1100 may include receiving, from a network node, a configuration for a PCell associated with an FDD carrier and an SCell associated with an SDL carrier (block 1110). For example, the UE (e.g., using communication manager 150 or reception component 1202, depicted in FIG. 12) may receive, from a network node, a configuration for a PCell associated with an FDD carrier and an SCell associated with an SDL carrier, as described above, for example, with reference to FIGS. 3 and 6-8.

As further shown in FIG. 11, in some aspects, process 1100 may include communicating with one or more of the PCell or the SCell based at least in part on an SCell activation status, wherein the communicating includes communicating only with the PCell or communicating only with the SCell in each TTI (block 1120). For example, the UE (e.g., using communication manager 150, reception component 1202, or transmission component 1204, depicted in FIG. 12) may communicate with one or more of the PCell or the SCell based at least in part on an SCell activation status, wherein the communicating includes communicating only with the PCell or communicating only with the SCell in each TTI, as described above, for example, with reference to FIGS. 6, 7, 8A, 8B, 9 or 10.

Process 1100 may include additional aspects, such as any single aspect or any combination of aspects described below or in connection with one or more other processes described elsewhere herein.

In a first aspect, process 1100 includes receiving, from the network node, information indicating a pattern for switching between the PCell and the SCell, where the pattern for switching between the PCell and the SCell is not applied and the communicating includes communicating only with the PCell while the SCell activation status is inactive.

In a second aspect, alone or in combination with the first aspect, process 1100 includes receiving, from the network node, an activation command for the SCell while the activation status for the SCell is deactivated, wherein the communicating includes communicating only with the SCell during a transition period after receiving the activation command until the SCell activation status is active.

In a third aspect, alone or in combination with one or more of the first and second aspects, process 1100 includes receiving, from the network node, information indicating a pattern for switching between the PCell and the SCell, wherein the communicating includes switching between communicating with the PCell for a first duration and communicating with the SCell for a second duration according to the indicated pattern while the SCell activation status is active.

In a fourth aspect, alone or in combination with one or more of the first through third aspects, process 1100 includes receiving, from the network node, information indicating multiple patterns for switching between the PCell and the SCell, and selecting, from the multiple patterns, a pattern for switching between the PCell and the SCell based at least in part on the SCell activation status.

In a fifth aspect, alone or in combination with one or more of the first through fourth aspects, the selected pattern is associated with communicating with the SCell for a duration that satisfies an activation time and a CQI measurement time associated with the SCell while the SCell activation status is deactivated or the SCell activation status is transitioning from inactive to active.

In a sixth aspect, alone or in combination with one or more of the first through fifth aspects, the selected pattern is associated with communicating with the PCell for a first duration and communicating with the SCell for a second duration while the SCell activation status is active.

In a seventh aspect, alone or in combination with one or more of the first through sixth aspects, the selected pattern is associated with invalidating one or more cell-specific signals associated with the PCell for a duration associated with communicating with the SCell.

In an eighth aspect, alone or in combination with one or more of the first through seventh aspects, process 1100 includes receiving, from the network node, an activation command for the SCell while the SCell activation status is inactive, wherein the communicating includes switching between the PCell and the SCell to measure one or more SSBs and obtain a CQI associated with the SCell during a transition period associated with the activation command.

In a ninth aspect, alone or in combination with one or more of the first through eighth aspects, switching between the PCell and the SCell includes communicating only with the PCell for a first duration, interrupting communication with the PCell and communicating only with the SCell for a second duration associated with measuring the one or more SSBs from the SCell, resuming communication with the PCell and communicating only with the PCell for a third duration associated with receiving a CSI trigger associated with the SCell, interrupting communication with the PCell and communicating only with the SCell for a fourth duration associated with obtaining the CQI associated with the SCell according to the CSI trigger, and resuming communication with the PCell and communicating only with the PCell for a fifth duration associated with transmitting a CSI report that indicates the CQI associated with the SCell.

In a tenth aspect, alone or in combination with one or more of the first through ninth aspects, switching between the PCell and the SCell includes communicating only with the PCell for a first duration, interrupting communication with the PCell and communicating only with the SCell for a second duration associated with measuring the one or more SSBs and obtaining the CQI associated with the SCell, and resuming communication with the PCell and communicating only with the PCell for a third duration associated with transmitting a CSI report that indicates the CQI associated with the SCell.

In an eleventh aspect, alone or in combination with one or more of the first through tenth aspects, switching between the PCell and the SCell includes interrupting communication with the PCell for one or more durations associated with one or more of an SSB duration, an SMTC duration, a CSI-RS duration, a CSI trigger duration, or a bidirectional switching time associated with switching between the PCell and the SCell.

In a twelfth aspect, alone or in combination with one or more of the first through eleventh aspects, process 1100 includes receiving, from the network node, information indicating a pattern for switching between the PCell and the SCell, wherein the communicating includes switching between the PCell and the SCell according to the indicated pattern after the transition period associated with the activation command.

In a thirteenth aspect, alone or in combination with one or more of the first through twelfth aspects, process 1100 includes receiving, from the network node, information indicating a pattern for switching between the PCell and the SCell, and receiving, from the network node, an activation command for the SCell while the activation status for the SCell is deactivated, wherein the communicating includes switching between the PCell and the SCell according to the pattern during a transition period associated with the activation command.

In a fourteenth aspect, alone or in combination with one or more of the first through twelfth thirteenth aspects, the pattern is associated with communicating with the SCell for a duration that satisfies an activation time and a CQI measurement time associated with the SCell, and the communicating includes switching between the PCell and the SCell according to the pattern to measure one or more SSBs and obtain a CQI associated with the SCell during a transition period associated with the activation command.

In a fifteenth aspect, alone or in combination with one or more of the first through fourteenth aspects, the one or more SSBs include one or more on-demand SSBs associated with the SCell.

In a sixteenth aspect, alone or in combination with one or more of the first through fifteenth aspects, process 1100 includes receiving, from the network node, a CSI trigger associated with the SCell after receiving the activation command for the SCell and prior to transmitting an acknowledgement message associated with the activation command, wherein the CSI trigger configures CSI-RS resources that follow one or more SSB resources in the SCell within the duration that satisfies the activation time and the CQI measurement time associated with the SCell.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram of an example apparatus 1200 for wireless communication. The apparatus 1200 may be a UE 120, or a UE 120 may include the apparatus 1200. In some aspects, the apparatus 1200 includes a reception component 1202 and a transmission component 1204, which may be in communication with one another (for example, via one or more buses or one or more other components). As shown, the apparatus 1200 may communicate with another apparatus 1206 (such as a UE, a base station, or another wireless communication device) using the reception component 1202 and the transmission component 1204. As further shown, the apparatus 1200 may include the communication manager 150. The communication manager 150 may include a switching component 1208, among other examples. The communication manager 150 may be included in, or implemented via, a processing system (for example, the processing system 140 described in connection with FIG. 1) of the UE 120.

In some aspects, the apparatus 1200 may be configured to perform one or more operations described herein in connection with FIGS. 6, 7, 8A, 8B, 9 or 10. Additionally, or alternatively, the apparatus 1200 may be configured to perform one or more processes described herein, such as process 1100 of FIG. 11. In some aspects, the apparatus 1200 or one or more components shown in FIG. 12 may include one or more components of the UE 120 described in connection with FIG. 1. Additionally, or alternatively, one or more components shown in FIG. 12 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1202 may receive communications, such as reference signals, control information, data communications, or a combination thereof, from the apparatus 1206. The reception component 1202 may provide received communications to one or more other components of the apparatus 1200. In some aspects, the reception component 1202 may perform signal processing on the received communications, and may provide the processed signals to the one or more other components of the apparatus 1200. In some aspects, the reception component 1202 may include one or more components of the UE 120 described above in connection with FIG. 1, such as a radio, one or more RF chains, one or more transceivers, or one or more modems, each of which may in turn be coupled with one or more antennas of the UE 120.

The transmission component 1204 may transmit communications, such as reference signals, control information, data communications, or a combination thereof, to the apparatus 1206. In some aspects, one or more other components of the apparatus 1200 may generate communications and may provide the generated communications to the transmission component 1204 for transmission to the apparatus 1206. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1206. In some aspects, the transmission component 1204 may include one or more components of the UE 120 described above in connection with FIG. 1, such as a radio, one or more RF chains, one or more transceivers, or one or more modems, each of which may in turn be coupled with one or more antennas of the UE 120 described in connection with FIG. 1. In some aspects, the transmission component 1204 may be co-located with the reception component 1202.

The reception component 1202 may receive, from a network node, a configuration for a PCell associated with an FDD carrier and an SCell associated with an SDL carrier. The reception component 1202, the transmission component 1204, or the switching component 1208 may communicate with one or more of the PCell or the SCell based at least in part on an SCell activation status, wherein the communicating includes communicating only with the PCell or communicating only with the SCell in each TTI.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

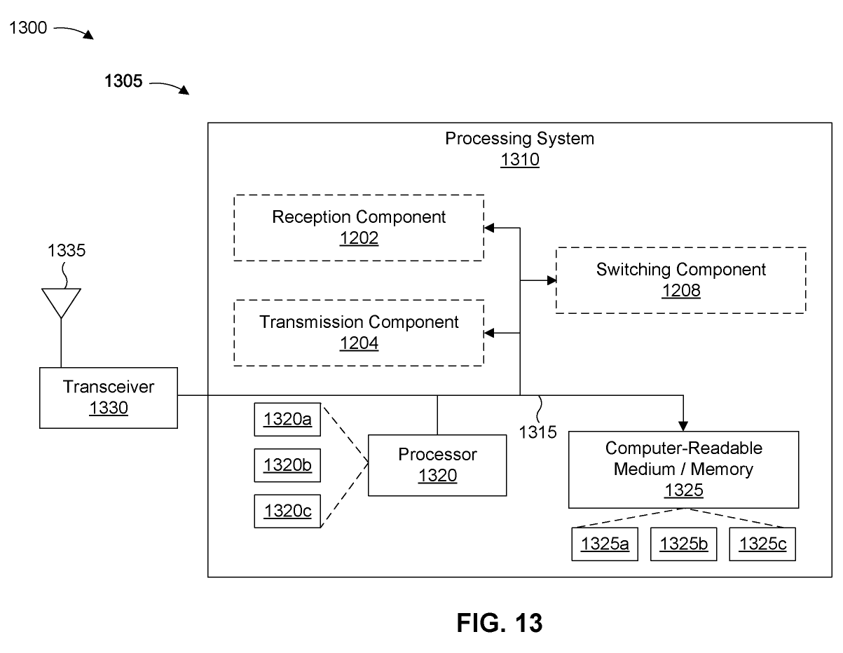

FIG. 13 is a diagram illustrating an example 1300 of a hardware implementation for an apparatus 1305 employing a processing system 1310. The apparatus 1305 may be a UE 120 or may be at (e.g., included in) a UE 120. The processing system 1310 may be, or may be similar to, the processing system 140 of the UE 120 described in connection with FIG. 1.

The processing system 1310 may be implemented with a bus architecture, represented generally by the bus 1315. The bus 1315 may include any number of interconnecting buses and bridges depending on the specific application of the processing system 1310 and the overall design constraints. The bus 1315 links together various circuits including one or more processors or hardware components, represented by the processor (or processing circuitry) 1320, the illustrated components, and the computer-readable medium / memory (or memory circuitry) 1325. The processor 1320 may include multiple processors, such as processor 1320a, processor 1320b, and processor 1320c. The memory 1325 may include multiple memories, such as memory 1325a, memory 1325b, and memory 1325c The bus 1315 may also link various other circuits, such as timing sources, peripherals, voltage regulators, or power management circuits.

The processing system 1310 may be coupled to one or more transceivers 1330. A transceiver 1330 is coupled to one or more antennas 1335. The transceiver 1330 provides a means for communicating with various other apparatuses over a transmission medium. The transceiver 1330 receives a signal from the one or more antennas 1335, extracts information from the received signal, and provides the extracted information to the processing system 1310, specifically the reception component 1202. In addition, the transceiver 1330 receives information from the processing system 1310, specifically the transmission component 1204, and generates a signal to be applied to the one or more antennas 1335 based at least in part on the received information.

The processing system 1310 includes one or more processors 1320 coupled to a computer-readable medium / memory 1325. A processor 1320 is responsible for general processing, including the execution of software stored on the computer-readable medium / memory 1325. The software, when executed by the processor 1320, causes the processing system 1310 to perform the various functions described herein for any particular apparatus. The computer-readable medium / memory 1325 may also be used for storing data that is manipulated by the processor 1320 when executing software. The processing system further includes at least one of the illustrated components. The components may be software modules running in the processor 1320, resident/stored in the computer readable medium / memory 1325, one or more hardware modules coupled to the processor 1320, or some combination thereof.

In some aspects, the processing system 1310 may be a component of the UE 120 or may be, may include, or may be included in the processing system 140 of the UE 120 described in connection with FIG. 1. In some aspects, the apparatus 1305 for wireless communication includes means for means for receiving, from a network node, a configuration for a PCell associated with an FDD carrier and an SCell associated with an SDL carrier; and means for communicating with one or more of the PCell or the SCell based at least in part on an SCell activation status, wherein the communicating includes communicating only with the PCell or communicating only with the SCell in each TTI. The aforementioned means may be one or more of the aforementioned components of the apparatus 1200 or the processing system 1310 of the apparatus 1305 configured to perform the functions recited by the aforementioned means. As described elsewhere herein, the processing system 1310 may include one or more components of the processing system 140 of the UE 120 described in connection with FIG. 1. In one configuration, the aforementioned means may be the processing system 140 or one or more components of the processing system 140 configured to perform the functions or operations recited herein.

The following provides an overview of some Aspects of the present disclosure:

Aspect 1: A method of wireless communication performed by a UE, comprising: receiving, from a network node, a configuration for a PCell associated with an FDD carrier and an SCell associated with an SDL carrier; and communicating with one or more of the PCell or the SCell based at least in part on an SCell activation status, wherein the communicating includes communicating only with the PCell or communicating only with the SCell in each TTI.

Aspect 2: The method of Aspect 1, further comprising: receiving, from the network node, information indicating a pattern for switching between the PCell and the SCell, wherein the pattern for switching between the PCell and the SCell is not applied and the communicating includes communicating only with the PCell while the SCell activation status is inactive.

Aspect 3: The method of any of Aspects 1-2, further comprising: receiving, from the network node, an activation command for the SCell while the activation status for the SCell is deactivated, wherein the communicating includes communicating only with the SCell during a transition period after receiving the activation command until the SCell activation status is active.

Aspect 4: The method of any of Aspects 1-3, further comprising: receiving, from the network node, information indicating a pattern for switching between the PCell and the SCell, wherein the communicating includes switching between communicating with the PCell for a first duration and communicating with the SCell for a second duration according to the indicated pattern while the SCell activation status is active.

Aspect 5: The method of any of Aspects 1-4, further comprising: receiving, from the network node, information indicating multiple patterns for switching between the PCell and the SCell; and selecting, from the multiple patterns, a pattern for switching between the PCell and the SCell based at least in part on the SCell activation status.

Aspect 6: The method of Aspect 5, wherein the selected pattern is associated with communicating with the SCell for a duration that satisfies an activation time and a CQI measurement time associated with the SCell while the SCell activation status is deactivated or the SCell activation status is transitioning from inactive to active.

Aspect 7: The method of Aspect 5, wherein the selected pattern is associated with communicating with the PCell for a first duration and communicating with the SCell for a second duration while the SCell activation status is active.

Aspect 8: The method of Aspect 5, wherein the selected pattern is associated with invalidating one or more cell-specific signals associated with the PCell for a duration associated with communicating with the SCell.

Aspect 9: The method of any of Aspects 1-8, further comprising: receiving, from the network node, an activation command for the SCell while the SCell activation status is inactive, wherein the communicating includes switching between the PCell and the SCell to measure one or more SSBs and obtain a CQI associated with the SCell during a transition period associated with the activation command.

Aspect 10: The method of Aspect 9, wherein switching between the PCell and the SCell includes: communicating only with the PCell for a first duration; interrupting communication with the PCell and communicating only with the SCell for a second duration associated with measuring the one or more SSBs from the SCell; resuming communication with the PCell and communicating only with the PCell for a third duration associated with receiving a CSI trigger associated with the SCell; interrupting communication with the PCell and communicating only with the SCell for a fourth duration associated with obtaining the CQI associated with the SCell according to the CSI trigger; and resuming communication with the PCell and communicating only with the PCell for a fifth duration associated with transmitting a CSI report that indicates the CQI associated with the SCell.

Aspect 11: The method of Aspect 9, wherein switching between the PCell and the SCell includes: communicating only with the PCell for a first duration; interrupting communication with the PCell and communicating only with the SCell for a second duration associated with measuring the one or more SSBs and obtaining the CQI associated with the SCell; and resuming communication with the PCell and communicating only with the PCell for a third duration associated with transmitting a CSI report that indicates the CQI associated with the SCell.

Aspect 12: The method of any of Aspects 9-11, wherein switching between the PCell and the SCell includes interrupting communication with the PCell for one or more durations associated with one or more of an SSB duration, an SMTC duration, a CSI-RS duration, a CSI trigger duration, or a bidirectional switching time associated with switching between the PCell and the SCell.

Aspect 13: The method of any of Aspects 9-12, further comprising: receiving, from the network node, information indicating a pattern for switching between the PCell and the SCell, wherein the communicating includes switching between the PCell and the SCell according to the indicated pattern after the transition period associated with the activation command.

Aspect 14: The method of any of Aspects 1-13, further comprising: receiving, from the network node, information indicating a pattern for switching between the PCell and the SCell; and receiving, from the network node, an activation command for the SCell while the activation status for the SCell is deactivated, wherein the communicating includes switching between the PCell and the SCell according to the pattern during a transition period associated with the activation command.

Aspect 15: The method of Aspect 14, wherein the pattern is associated with communicating with the SCell for a duration that satisfies an activation time and a CQI measurement time associated with the SCell, and wherein the communicating includes switching between the PCell and the SCell according to the pattern to measure one or more SSBs and obtain a CQI associated with the SCell during a transition period associated with the activation command.

Aspect 16: The method of Aspect 15, wherein the one or more SSBs include one or more on-demand SSBs associated with the SCell.

Aspect 17: The method of any of Aspects 15-16, further comprising: receiving, from the network node, a CSI trigger associated with the SCell after receiving the activation command for the SCell and prior to transmitting an acknowledgement message associated with the activation command, wherein the CSI trigger configures CSI-RS resources that follow one or more SSB resources in the SCell within the duration that satisfies the activation time and the CQI measurement time associated with the SCell.

Aspect 18: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-17.

Aspect 19: An apparatus for wireless communication at a device, the apparatus comprising one or more memories and one or more processors coupled to the one or more memories, the one or more processors configured to cause the device to perform the method of one or more of Aspects 1-17.

Aspect 20: An apparatus for wireless communication, the apparatus comprising at least one means for performing the method of one or more of Aspects 1-17.

Aspect 21: A non-transitory computer-readable medium storing code for wireless communication, the code comprising instructions executable by one or more processors to perform the method of one or more of Aspects 1-17.

Aspect 22: A non-transitory computer-readable medium storing a set of instructions for wireless communication, the set of instructions comprising one or more instructions that, when executed by one or more processors of a device, cause the device to perform the method of one or more of Aspects 1-17.

Aspect 23: A device for wireless communication, the device comprising a processing system that includes one or more processors and one or more memories coupled with the one or more processors, the processing system configured to cause the device to perform the method of one or more of Aspects 1-17.

Aspect 24: An apparatus for wireless communication at a device, the apparatus comprising one or more memories and one or more processors coupled to the one or more memories, the one or more processors individually or collectively configured to cause the device to perform the method of one or more of Aspects 1-17.

Aspect 25: A device comprising a processing system that includes one or more processors and one or more code-storing memories coupled with the one or more processors, the processing system configured to cause the device to perform the method of one or more of Aspects 1-17.

Aspect 26: A device comprising a processing system that includes processor circuitry and code-storing memory circuitry, the processing system configured to cause the device to perform the method of one or more of Aspects 1-17.

It will be apparent that systems or methods described herein may be implemented in different forms of hardware or a combination of hardware and software. A component being configured to perform a function means that the component has a capability to perform the function, and does not require the function to be actually performed by the component, unless noted otherwise.

As used herein, the term “determine” or “determining” can encompass one or more of a wide variety of actions. For example, “determining” can include one or more of calculating, computing, processing, deriving, detecting, estimating, investigating, looking up, inferring, ascertaining, measuring, resolving, selecting, choosing, obtaining, identifying, interpreting, demodulating, decoding, reading, establishing, forming or generating, among other examples. In some such examples, determining can involve a processor performing some type of calculating, computing, deriving, estimating, inferring, ascertaining, resolving, predicting or other processing to obtain one or more numerical values, sets, elements or other information or results. In some other such examples, determining can involve a processor identifying, looking up, investigating or otherwise obtaining some type of value, set, element or other information or result from a table, a data structure, a database or other memory device or location. In some other such examples, determining can involve a processor identifying, interpreting, demodulating, decoding, detecting, reading or otherwise obtaining some type of value, set, element or other information or result signaled in, for example, a received wireless packet. In some other such examples, determining can involve a processor selecting or choosing one or more values, sets, elements or other information or results from a larger set of values, sets elements or other information or results. In some other such examples, determining can involve a processor performing a measurement, such as on a received signal.

As used herein, the articles “a” and “an” are intended to refer to one or more items and may be used interchangeably with “one or more” or “at least one.” As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Additionally, as used herein, a “set” can refer to one or more items, and a “subset” can refer to a whole set or less than the whole set, but not an empty set. “Set,” “group,” and similar terms are intended to include one or more items and may be used interchangeably with “one or more.” Furthermore, as used herein, the term “or” is intended to be interpreted in the inclusive sense (such as when referring to a series) and may be used interchangeably with “and/or,” unless otherwise explicitly indicated (for example, if used in conjunction with “either” or “only one of”). For example, “A or B” may include A only, B only, or a combination of A and B. Also, as used herein, the terms “has,” “have,” “having,” “comprise,” “comprising,” “include” and “including,” and derivatives thereof or similar terms are intended to be open-ended terms that do not limit an element that they modify (for example, an element “having” A also may have B).

As used herein, the phrase “associated with” is intended to be interpreted in the inclusive sense, unless otherwise explicitly indicated. For example, the phrase “associated with” is not to be construed as a reference to a closed set of conditions, factors, criteria, elements, components, or actions, among other examples. Specifically, unless a phrase refers to “associated with only ‘a,’” or the equivalent in context, whatever it is that is “associated with ‘a,’” may be associated with “a” alone or associated with a combination of “a” and one or more other conditions, factors, criteria, elements, components, or actions, among other examples. In various examples, the phrase “associated with” may be interpreted to mean “in association with,” “in accordance with,” “based on,” “based at least in part on,” “as a function of,” “in response to,” “responsive to,” or “using” as appropriate in the relevant context unless otherwise explicitly indicated. Furthermore, what follows the phrase “associated with,” “in association with,” “in accordance with,” “based on,” “based at least in part on,” “as a function of,” “in response to,” “responsive to,” or “using” is not necessarily the focal point or primary factor associated with the limitation preceding the phrase.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A user equipment (UE), comprising:
a processing system that includes one or more processors and one or more code-storing memories coupled with the one or more processors, the processing system configured to cause the UE to:
receive, from a network node, a configuration for a primary cell (PCell) associated with a frequency division duplexing (FDD) carrier and a secondary cell (SCell) associated with a supplemental downlink (SDL) carrier; and
communicate with one or more of the PCell or the SCell based at least in part on an SCell activation status, wherein the communicating includes communicating only with the PCell or communicating only with the SCell in each transmission time interval (TTI).

2. The UE of claim 1, wherein the processing system is further configured to cause the UE to:
receive, from the network node, information indicating a pattern for switching between the PCell and the SCell, wherein the pattern for switching between the PCell and the SCell is not applied and the communicating includes communicating only with the PCell while the SCell activation status is inactive.

3. The UE of claim 1, wherein the processing system is further configured to cause the UE to:
receive, from the network node, an activation command for the SCell while the activation status for the SCell is deactivated, wherein the communicating includes communicating only with the SCell during a transition period after receiving the activation command until the SCell activation status is active.

4. The UE of claim 1, wherein the processing system is further configured to cause the UE to:
receive, from the network node, information indicating a pattern for switching between the PCell and the SCell, wherein the communicating includes switching between communicating with the PCell for a first duration and communicating with the SCell for a second duration according to the indicated pattern while the SCell activation status is active.

5. The UE of claim 1, wherein the processing system is further configured to cause the UE to:
receive, from the network node, information indicating multiple patterns for switching between the PCell and the SCell; and
select, from the multiple patterns, a pattern for switching between the PCell and the SCell based at least in part on the SCell activation status.

6. The UE of claim 5, wherein the selected pattern is associated with communicating with the SCell for a duration that satisfies an activation time and a channel quality indicator (CQI) measurement time associated with the SCell while the SCell activation status is deactivated or the SCell activation status is transitioning from inactive to active.

7. The UE of claim 5, wherein the selected pattern is associated with communicating with the PCell for a first duration and communicating with the SCell for a second duration while the SCell activation status is active.

8. The UE of claim 5, wherein the selected pattern is associated with invalidating one or more cell-specific signals associated with the PCell for a duration associated with communicating with the SCell.

9. The UE of claim 1, wherein the processing system is further configured to cause the UE to:
receive, from the network node, an activation command for the SCell while the SCell activation status is inactive, wherein the communicating includes switching between the PCell and the SCell to measure one or more synchronization signal blocks (SSBs) and obtain a channel quality indicator (CQI) associated with the SCell during a transition period associated with the activation command.

10. The UE of claim 9, wherein to switch between the PCell and the SCell, the processing system is further configured to cause the UE to:
communicate only with the PCell for a first duration;
interrupt communication with the PCell and communicating only with the SCell for a second duration associated with measuring the one or more SSBs from the SCell;
resume communication with the PCell and communicating only with the PCell for a third duration associated with receiving a channel state information (CSI) trigger associated with the SCell;
interrupt communication with the PCell and communicating only with the SCell for a fourth duration associated with obtaining the CQI associated with the SCell according to the CSI trigger; and
resume communication with the PCell and communicating only with the PCell for a fifth duration associated with transmitting a CSI report that indicates the CQI associated with the SCell.

11. The UE of claim 9, wherein to switch between the PCell and the SCell, the processing system is further configured to cause the UE to:
communicate only with the PCell for a first duration;
interrupt communication with the PCell and communicating only with the SCell for a second duration associated with measuring the one or more SSBs and obtaining the CQI associated with the SCell; and
resume communication with the PCell and communicating only with the PCell for a third duration associated with transmitting a CSI report that indicates the CQI associated with the SCell.

12. The UE of claim 9, wherein switching between the PCell and the SCell includes interrupting communication with the PCell for one or more durations associated with one or more of an SSB duration, an SSB measurement timing configuration (SMTC) duration, a channel state information (CSI) reference signal (CSI-RS) duration, a CSI trigger duration, or a bidirectional switching time associated with switching between the PCell and the SCell.

13. The UE of claim 9, wherein the processing system is further configured to cause the UE to:
receive, from the network node, information indicating a pattern for switching between the PCell and the SCell, wherein the communicating includes switching between the PCell and the SCell according to the indicated pattern after the transition period associated with the activation command.

14. The UE of claim 1, wherein the processing system is further configured to cause the UE to:
receive, from the network node, information indicating a pattern for switching between the PCell and the SCell; and
receive, from the network node, an activation command for the SCell while the activation status for the SCell is deactivated, wherein the communicating includes switching between the PCell and the SCell according to the pattern during a transition period associated with the activation command.

15. The UE of claim 14, wherein the pattern is associated with communicating with the SCell for a duration that satisfies an activation time and a channel quality indicator (CQI) measurement time associated with the SCell, and wherein the communicating includes switching between the PCell and the SCell according to the pattern to measure one or more synchronization signal blocks (SSBs) and obtain a CQI associated with the SCell during a transition period associated with the activation command.

16. The UE of claim 15, wherein the processing system is further configured to cause the UE to:
receive, from the network node, a channel state information (CSI) trigger associated with the SCell after receiving the activation command for the SCell and prior to transmitting an acknowledgement message associated with the activation command, wherein the CSI trigger configures CSI reference signal (CSI-RS) resources that follow one or more SSB resources in the SCell within the duration that satisfies the activation time and the CQI measurement time associated with the SCell.

17. A method of wireless communication performed by a user equipment (UE), comprising:
receiving, from a network node, a configuration for a primary cell (PCell) associated with a frequency division duplexing (FDD) carrier and a secondary cell (SCell) associated with a supplemental downlink (SDL) carrier; and
communicating with one or more of the PCell or the SCell based at least in part on an SCell activation status, wherein the communicating includes communicating only with the PCell or communicating only with the SCell in each transmission time interval (TTI).

18. The method of claim 17, further comprising:
receiving, from the network node, information indicating a pattern for switching between the PCell and the SCell, wherein the pattern for switching between the PCell and the SCell is not applied and the communicating includes communicating only with the PCell while the SCell activation status is inactive.

19. The method of claim 17, further comprising:
receiving, from the network node, information indicating a pattern for switching between the PCell and the SCell, wherein the communicating includes switching between communicating with the PCell for a first duration and communicating with the SCell for a second duration according to the indicated pattern while the SCell activation status is active.

20. An apparatus for wireless communication, comprising:
means for receiving, from a network node, a configuration for a primary cell (PCell) associated with a frequency division duplexing (FDD) carrier and a secondary cell (SCell) associated with a supplemental downlink (SDL) carrier; and
means for communicating with one or more of the PCell or the SCell based at least in part on an SCell activation status, wherein the communicating includes communicating only with the PCell or communicating only with the SCell in each transmission time interval (TTI).
